(19) United States
(12) Patent Application Publication
(10) Pub. No.: US 2026/0035989 A1
(43) Pub. Date: Feb. 5, 2026

(54) SPACER FRAME ASSEMBLY AND METHOD OF MANUFACTURING

(71) Applicant: GED Integrated Solutions, Solon, OH (US)

(72) Inventors: Timothy Bryan McGlinchy, Twinsburg, OH (US); Matthew B. Persons, Akron, OH (US)

(21) Appl. No.: 19/288,945

(22) Filed: Aug. 1, 2025

Related U.S. Application Data
(60) Provisional application No. 63/678,407, filed on Aug. 1, 2024.

(51) Int. Cl. E06B 3/673; B21B 1/22; E06B 3/663

(52) U.S. Cl. CPC E06B 3/67313; B21B 1/22; E06B 3/66323; E06B 2003/66395

(57) ABSTRACT

An assembly and method of drawing differing types of sheet stock through one or more assembly stations to make a spacer frame that is used in an insulating glass unit is disclosed. The assembly and method include fabrication of a spacer frame having a recess formation in a portion of a peripheral wall of a connecting structure that allows two ends of the spacer frame to form a lateral connection. The assembly and method further include feeding along a process axis formed by a path of travel of the material an elongated length of sheet stock into a feeder press and a roll former, both having translating rollers that move transversely to the process axis to accommodate different materials used in the sheet stock. The assembly and method also include a swaging assembly for forming a recess formation in a portion of the peripheral wall of the spacer frame.

### CROSS REFERENCES TO RELATED APPLICATIONS

The following application claims priority under 35 U.S. C. § 119 (e) to co-pending U.S. Provisional Patent Application Ser. No. 63/678,407 filed Aug. 1, 2024 entitled SPACER FRAME ASSEMBLY AND METHOD OF MANUFACTURING. The above-identified application is incorporated herein by reference in its entirety for all purposes.

### TECHNICAL FIELD

The present disclosure generally relates to a spacer frame assembly and method of manufacturing, more particularly, a spacer frame assembly and method of manufacture for both a substantially metal spacer frame and a composite spacer frame made of metal having a polymeric thermal barrier, the spacer frames being used, for example, in a window or door.

### BACKGROUND

Insulating glass units (IGUs) are used in windows and doors to reduce heat loss from building interiors during cold weather and resist the entrance of heat during warm weather. IGUs are typically formed by a spacer assembly sandwiched between glass lites. A spacer assembly usually comprises a frame structure extending peripherally about the unit, a sealant material adhered both to the glass lites and the frame structure, and a desiccant for absorbing atmospheric moisture within the unit. The margins or the glass lites are flush with or extend slightly outwardly from the spacer assembly. The sealant extends continuously about the frame structure periphery and its opposite sides so that the space within the IGUs is hermetic.

There have been numerous proposals for constructing IGUs. One type of IGU was constructed from an elongated corrugated sheet metal strip-like frame embedded in a body of sealant material. Desiccant was also embedded in the sealant. The resulting composite spacer was packaged for transport and storage by coiling it into drum-like containers. When fabricating an IGU the composite spacer was partially uncoiled and cut to length. The spacer was then bent into a rectangular shape and sandwiched between conforming glass lites.

Particulate desiccant deposited inside the tubular frame elements communicated with air trapped in the IGU interior to remove the entrapped airborne water vapor and thus preclude its condensation within the unit. Thus, after the water vapor entrapped in the IGU was removed internal condensation only occurred when the unit failed.

In some cases, the sheet metal was roll formed into a continuous tube, with desiccant inserted, and fed to cutting stations where “V” shaped notches were cut in the tube at corner locations. The tube was then cut to length and bent into an appropriate frame shape. The continuous spacer frame, with an appropriate sealant in place, was then assembled in an IGU.

Alternatively, individual roll formed spacer frame tubes were cut to length and “corner keys” were inserted between adjacent frame element ends to form the corners. In some constructions the corner keys were foldable so that the sealant could be extruded onto the frame sides as the frame moved linearly past a sealant extrusion station. The frame was then folded to a rectangular configuration with the sealant in place on the opposite sides. The spacer assembly thus formed was placed between glass lites and the IGU assembly completed. IGUs have failed because atmospheric water vapor infiltrated the sealant barrier. Infiltration tended to occur at the frame corners because the opposite frame sides were at least partly discontinuous there. For example, frames where the corners were formed by cutting “V” shaped notches at corner locations in a single long tube. The notches enabled bending the tube to form mitered corner joints; but afterwards potential infiltration paths extended along the corner parting lines substantially across the opposite frame faces at each corner. Likewise, in IGUs employing corner keys, potential infiltration paths were formed by the junctures of the keys and frame elements. Furthermore, when such frames were folded into their final forms with sealant applied, the amount of sealant at the frame corners tended to be less than the amount deposited along the frame sides. Reduced sealant at the frame corners tended to cause vapor leakage paths.

In all these proposals the frame elements had to be cut to length in one way or another and, in the case of frames connected together by corner keys, the keys were installed before applying the sealant. These were all manual operations which limited production rates. Accordingly, fabricating IGUs from these frames entailed generating appreciable amounts of scrap and performing inefficient manual operations.

In spacer frame constructions where the roll forming occurred immediately before the spacer assembly was completed, sawing, desiccant filling and frame element end plugging operations had to be performed by hand which greatly slowed production of units. U.S. Pat. No. 5,361,476 to Leopold discloses a method and apparatus for making IGUs wherein a thin flat strip of sheet material is continuously formed into a channel shaped spacer frame having corner structures and end structures. The spacer thus formed is cut off, sealant and desiccant are applied, and the assemblage is bent to form a spacer assembly. U.S. Pat. No. 5,361,476 is incorporated herein by reference in its entirety for all purposes.

### SUMMARY

One aspect of the present disclosure includes an assembly and method of drawing differing types of sheet stock through one or more assembly stations to make a spacer frame that is used in an insulating glass unit. The assembly and method include the fabrication of a spacer frame having a recessed formation in a portion of a peripheral wall of a connecting structure that allows two ends of the spacer frame to form a lateral connection. The assembly and method further include feeding along a process axis formed by a path of travel of the material an elongated length of sheet stock into a feeder press and a roll former, both having one or more shifting rollers that move transversely to the process axis to accommodate different materials used in the sheet stock. The assembly and method also include a swaging assembly for forming a recessed formation in a portion of the peripheral wall of the spacer frame.

Another aspect of the present disclosure includes a plurality of machines of an assembly line for forming a metal spacer frame and a thermal spacer frame having a non-metal thermal barrier spacing first and second metal strips, each machine having a change-over to move forming details to transport and manufacture both the all metal spacer frame and polymeric thermal spacer frame.

Another aspect of the present disclosure includes an assembly and method of drawing differing types of sheet stock from a feeder press station. The assembly and method include feeding an elongated length of sheet stock during use into a feeder shuttle; drawing the elongated length of sheet stock through a set of pinch rollers; and shifting automatically the pinch rollers from a first position to a second position to accommodate different types of sheet stock.

Yet another aspect of the present disclosure includes a method of drawing differing sheet stock through a feeder press station, the method comprising the steps of feeding an elongated length of sheet stock from an uncoiler into the feeder press; drawing the elongated length of sheet stock through a set of pinch rollers along a process axis formed by a path in which the material travels during processing; and translating the pinch rollers from a first position to a second position to accommodate the processing of different types of sheet stock, wherein said translating occurs in a direction transverse to said process axis.

Yet another aspect of the present disclosure includes a method of roll forming differing sheet stock through a roll forming station, the method comprising the steps of: feeding an elongated length of sheet stock from a feeder roller into the roll former; drawing the elongated length of sheet stock through roll forming dies along process axis formed by a path in which the material travels during processing; and translating a drive roller from a first position to a second position to accommodate different types of sheet stock, wherein the shift is in a direction transverse to the process axis.

Another aspect of the present disclosure includes a method of swaging a portion of a thermal spacer frame. The method comprises the steps of feeding a u-shaped formed spacer frame from a feed roller into a swaging station. The method further comprises advancing an anvil along a direction transverse to an axis defined by the flow of material to a position in which the anvil engages the u-shaped spacer frame and advancing a first die along a second axis formed the direction transverse to the axis defined by the flow of material to a position in which the first die engages the u-shaped spacer frame. The method further includes advancing a second die along the second axis formed the direction transverse to the axis defined by the flow of material to a position in which the second die engages the u-shaped spacer frame such that a plane is formed by the contacting of the u-shaped spacer and the first die, second die, and anvil. The method also comprises further advancing the second die along the second axis beyond the plane to form a channel in a portion of a peripheral wall of the u-shaped channel.

While another aspect of the present disclosure includes a system comprising an assembly line for manufacturing a metallic spacer frame and a thermal spacer frame from a continuous sheet stock that is formed into a spacer frame through a series assembly stations comprising: a feeder press station that receives an elongated length of continuous sheet stock from an uncoiler during use; a set of pinch rollers along a having process axis formed by a path in which the continuous sheet stock travels during processing; the pinch rollers comprise a transfer assembly for translating from a first position to a second position to accommodate the processing of different types of continuous sheet stock, wherein the translating occurs in a direction transverse to the process axis; a roll forming station for receiving the continuous sheet stock from the feeder roller station into a roll former arrangement; the roll forming arrangement comprising a plurality of roll forming dies along the process axis formed by a path in which the continuous sheet stock travels during processing; and a drive roller that translates from a first position to a second position to accommodate different types of continuous sheet stock, wherein the translating is in a direction transverse to the process axis; and a swaging station comprising the process axis formed by the continuous sheet stock; an anvil and a two-stage die assembly that are activated when the continuous sheet stock includes a thermal barrier, the anvil and two-stage die assembly generating a formed trough in a portion of the continuous sheet stock during operation.

### DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is an isometric view of an insulating glass unit comprising a metal spacer frame spacing first and second glass lites constructed in accordance with one example embodiment;

FIG. 2 is a partial cross-sectional view seen approximately from the plane indicated by the line 2-2 of FIG. 1, the cross-sectional view illustrating a roll formed metal spacer frame spacing first and second lites in accordance with one example embodiment;

FIG. 3 is a fragmentary top plan view of a metal spacer frame in accordance with one example embodiment;

FIG. 4 is a fragmentary side-elevational view of the metal spacer frame of FIG. 3;

FIG. 5 is a top plan view of the metal spacer frame seen approximately from the plane indicated by the line 5-5 of FIG. 4 in accordance with one example embodiment;

FIG. 6 is an isometric view of an insulating glass unit comprising a thermal spacer frame having a non-metal thermal barrier spacing first and second metal strips, the thermal spacer frame sandwiched between first and second glass lites constructed in accordance with another example embodiment;

FIG. 7 is an isometric view of an insulating glass unit comprising a thermal spacer frame having a non-metal thermal barrier spacing first and second metal strips, the thermal spacer frame sandwiched between first and second glass lites and covered in sealant material and constructed in accordance with another example embodiment;

FIG. 8 is a partial cross-sectional view seen approximately from the plane indicated by the line 8-8 of FIG. 7, the cross-sectional view illustrating a roll formed thermal spacer frame spacing first and second lites in accordance with one example embodiment;

FIG. 9 is a fragmentary top plan view of a thermal spacer frame in accordance with one example embodiment;

FIG. 10 is a partial view of a first and second ends of the thermal spacer frame of FIG. 9 in accordance with an example embodiment;

FIG. 11 is a fragmentary side-elevational view of the thermal spacer frame of FIG. 9;

FIG. 12 is a top plan view of the thermal spacer frame seen approximately from the plane indicated by the line 12-12 of FIG. 11 in accordance with one example embodiment;

FIG. 13 is an end view of a thermal strip prior to roll-forming to make a thermal spacer frame, the thermal strip having a non-metal thermal barrier spacing first and second metal strips in accordance with one example embodiment;

FIG. 14 is an isometric view of a thermal spacer frame as it would appear after a roll forming operation, the thermal spacer frame having a non-metal barrier spacing first and second metal strips or walls in accordance with another example embodiment;

FIG. 15 is a perspective view of a thermal strip having a non-metal thermal barrier spacing and fixedly attaching first and second metal strips as it would appear prior to a roll forming operation in accordance with one example embodiment of the present disclosure;

FIG. 16 is a plan view of a metal spacer frame or thermal spacer frame being assembled into a folded position in accordance with one example embodiment;

FIG. 17 is a partial view of FIG. 16 of a metal spacer frame or thermal spacer frame transitioning from an uncoupled to a coupled position;

FIG. 18 is a cross sectional view of the thermal spacer frame of FIG. 16 along section lines 18-18 in accordance with one example embodiment;

FIG. 19 is a production assembly and network formed from a plurality of machines and controllers for making a metal spacer frame and a thermal spacer frame from strip stock in accordance with one example embodiment;

FIG. 20 is a production line of the production assembly comprising a feed roller with punching dies, roll former, and combined crimping and swaging station in accordance with one example embodiment;

FIG. 21 is a perspective view of a feed roller in accordance with one example embodiment;

FIG. 22 is a section view of the feed roller of FIG. 21 along lines 22-22;

FIG. 23 is a right side elevation view of the feed roller of FIG. 21;

FIG. 24 is a left side elevation view of the feed roller of FIG. 21;

FIG. 25 is a front elevation view of the feed roller of FIG. 21;

FIG. 26 is a partial plan view of the roll former of FIG. 28 roll forming a single material metal strip spacer frame in accordance with one example embodiment;

FIG. 27 is a partial plan view of the roll former of FIG. 28 roll forming a thermal strip spacer frame in accordance with one example embodiment;

FIG. 28 is a perspective view of a roll former;

FIGS. 29-31 illustrate a crimper assembly constructed in accordance with one example embodiment of the present disclosure;

FIGS. 32-35 illustrate a forming operation comprising swaging an end member of a thermal spacer frame in accordance with one example embodiment of the present disclosure;

FIG. 36 illustrates a perspective view of two space frame end members forming a telescopic connection in accordance with one example embodiment of the present disclosure;

FIG. 37 illustrates a tongue or tab end member in accordance with another example embodiment of the present disclosure;

FIG. 38 illustrate end members forming a telescopic joint of a composite spacer frame constructed in accordance with one example embodiment of the present disclosure;

FIG. 39 is a process diagram for a method of making a first spacer frame made from a single material and a spacer frame made from a combination of materials.

FIG. 40 illustrates a cutoff assembly with a swaging arrangement for retro-fitting assembly lines for full metal spacer frames to also produce thermal spacer frames via a swaging operation in accordance with one example embodiment of the present disclosure;

FIG. 41 illustrates a front view of a swaging device in accordance with one example embodiment of the present disclosure;

FIG. 42 illustrates a sequence of operation for a swaging device in accordance with one example embodiment of the present disclosure;

FIG. 43 illustrates a perspective view of an end member of a composite spacer frame in FIG. 16 in accordance with another example embodiment;

FIG. 44 illustrates a perspective view of an end member of a composite spacer frame in FIG. 16 in accordance with another example embodiment;

FIG. 45 illustrates a side elevation section view of a telescopic joint of a composite spacer frame in FIG. 16 using the end members of FIGS. 43 and 44 in accordance with another example embodiment;

FIG. 46 illustrates a perspective view of an end member of a composite spacer frame in FIG. 16 in accordance with another example embodiment;

FIG. 47 illustrates a perspective view of an end member of a composite spacer frame in FIG. 16 in accordance with another example embodiment;

FIG. 48 illustrates a side elevation section view of a telescopic joint of a composite spacer frame in FIG. 16 using the end members of FIGS. 46 and 47 in accordance with another example embodiment;

FIG. 49 illustrates a cross section of the spacer frame of FIG. 16 along section lines 49-49 in accordance with one example embodiment;

FIG. 50 illustrates a cross section of the spacer frame of FIG. 16 along section lines 50-50 in accordance with one example embodiment;

FIG. 51 illustrates a cross section of the spacer frame of FIG. 16 along section lines 51-51 in accordance with one example embodiment; and

FIG. 52 illustrates a cross section of the spacer frame of FIG. 16 along section lines 52-52 in accordance with one example embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure. Further, the utility and purpose of many structures are shown in the figures are described throughout the specification. However, it should be appreciated that some of the structures shown in the figures have been selected or invented for aesthetic appearance and ornamental design independent of its utilitarian operation or lack thereof.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures wherein like numbered features shown therein refer to like elements throughout unless otherwise noted. The present disclosure generally relates to a spacer frame assembly and method of manufacturing more particularly, a spacer frame assembly and method of manufacture for both a substantially metal spacer frame and a composite spacer frame made of metal and a thermal barrier, the spacer frames being used, for example in a window or door.

### The Insulating Glass Unit Using A Metal Spacer Frame

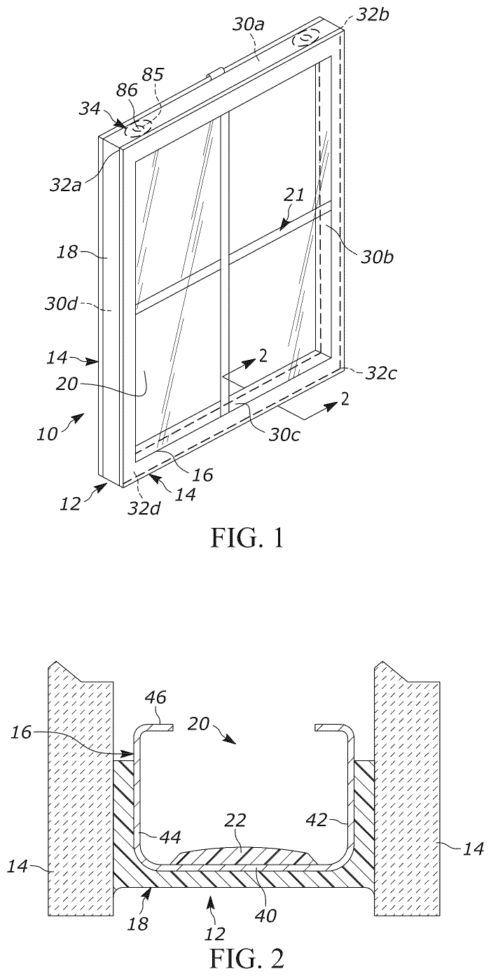

An insulating glass unit (IGU) 10 in FIG. 1 is constructed using a metal spacer frame illustrated in FIGS. 2-5 in accordance with methods and machinery of the present disclosure. The insulating glass unit 10 of FIG. 1 comprises a metal spacer frame assembly 12 sandwiched between glass sheets, or lites, 14. The insulating glass unit 10 comprises a metal frame structure 16, sealant material 18 for hermetically joining the frame to the lites 14 to form a closed space 20 within the unit 10 and a body 22 of desiccant in the space 20. The insulating glass unit 10 is illustrated in FIG. 1 is in condition for final assembly into a window or door frame, not illustrated, for ultimate installation in a building. The insulating glass unit 10 illustrated in FIG. 1 optionally includes muntin bars 21 that provide the appearance of individual windowpanes.

The metal spacer frame assembly 12 maintains the lites 14 in a spaced apart relationship from each other to produce the hermetic “insulating air space” 20 therebetween. The frame structure 16 of the metal spacer frame 12 along with the sealant body 18 co-act to provide a structure which maintains the lites 14 properly assembled with the space 20 scaled from atmospheric moisture over long time periods during which the insulating glass unit 10 is subjected to frequent significant environmental thermal stresses. The desiccant body 22 removes water vapor from air, or other volatiles, entrapped in the space 20 during construction of the insulating glass unit 10.

The sealant body 18 both structurally adheres the lites 14 to the metal spacer assembly 12 and hermetically closes the space 20 against infiltration of airborne water vapor from the atmosphere surrounding the unit 10. The illustrated sealant body 18 in FIG. 2 is formed from a sealing material, which is attached to the metal spacer frame 12 sides and outer periphery that is formed in a U-shaped cross section.

Returning to FIG. 1, the structural elements of the metal frame structure 16 of the metal spacer frame assembly 12 are produced by the method and apparatus of the present disclosure. The frame structure 16 extends about the insulating glass unit 10 periphery to provide a structurally strong, stable spacer for maintaining the lites 14 aligned and spaced while minimizing heat conduction between the lites via the structural frame.

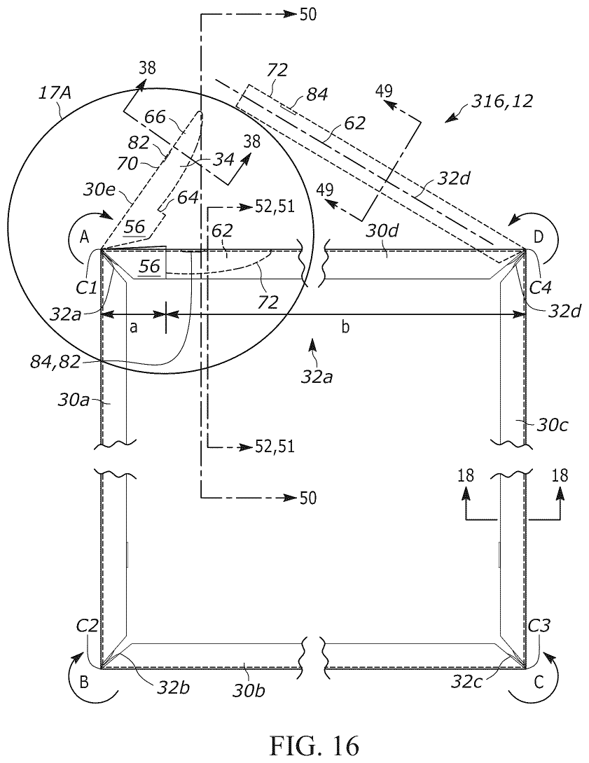

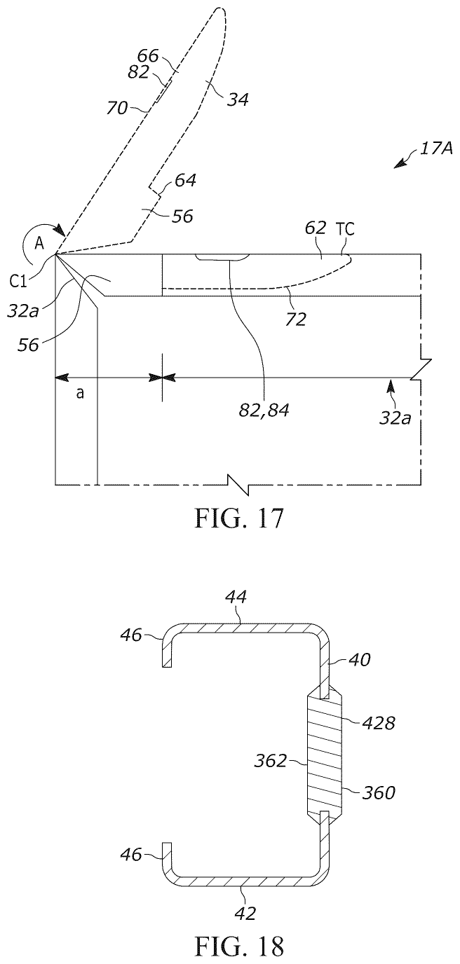

A metal spacer frame assembly 12 is illustrated in FIG. 16 in which the final two (30d and 30e) of five legs (30a-30e) are rotated to be joined to make a four-sided metal spacer frame structure 16. It should be appreciated that in the example embodiment of FIG. 16, the planar metal spacer frame assembly 12 is square, but it could also be any polygonal frame shape without departing from the spirit and scope of the present disclosure. The legs or connected members 30a-30d further connect and when folded form frame corner structures 32a-32d, and connecting structure 34 for joining opposite frame element ends to complete the closed frame shape shown in solid lines in FIG. 16.

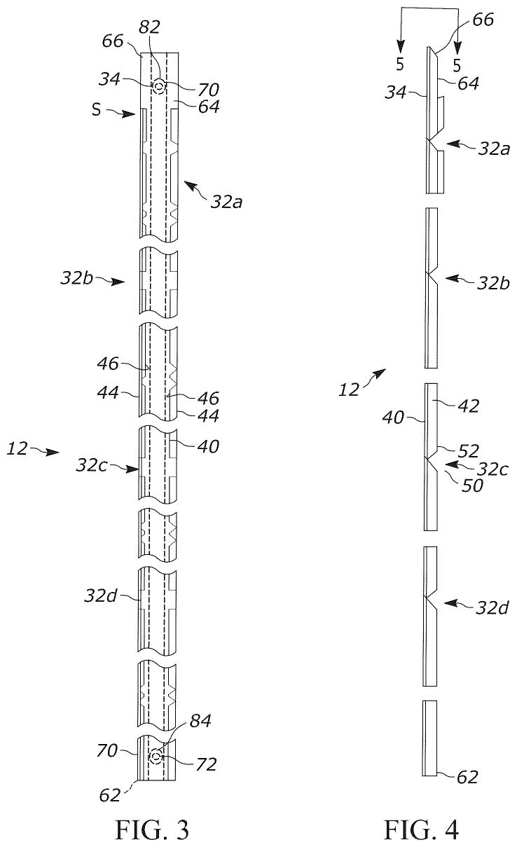

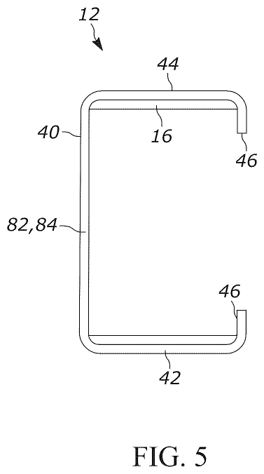

The metal spacer frame 12 is pulled from a coil of flat stock metal and advanced through a series of stations or machines of the present disclosure to form the metal frame structure 16 resulting in an elongated and a channel shaped cross section illustrated in FIGS. 3-5. The frame structure 16 includes a peripheral wall 40 and first and second lateral walls 42, 44 (see FIGS. 3-5). The peripheral wall 40 extends continuously about the metal spacer frame except where the connecting structure 34 joins the frame member ends 62, 64. The lateral walls 42, 44 are integral with respective opposite peripheral wall 40 edges. The lateral walls 42, 44 extend inwardly from the peripheral wall 40 in a direction parallel to the planes of the lites 14 when assembled to construct the insulating glass unit 10. The illustrated frame structure 16 has stiffening flanges 46 (see FIG. 5) formed along the inwardly projecting lateral wall 42, 44 edges. The lateral walls 42, 44 and flanges 46 add rigidity to the frame structure 16 so it resists flexure and bending in a direction transverse to its longitudinal extent. The flanges 46 stiffen the walls 42, 44 so they resist bending and flexure transverse to their longitudinal extents.

The metal spacer frame 12 and more specifically, the structural frame 16 is initially formed as a continuous straight flat stock constructed from a thin ribbon of stainless-steel material (e.g., 304 stainless steel having a thickness of, for example 0.006-0.010 inches). Other materials and metals, such as galvanized, tin-plated steel, or aluminum, may also be used to construct the channel. The corner structures 32 a-d (see FIGS. 3 and 4) are made to facilitate folding or bending the frame channel to the final, polygonal frame configuration, as shown in the example embodiment of FIG. 16 and the IGU 10 of FIG. 1, while assuring an effective vapor seal at the frame corners.

The corner structures 32 initially comprise notches 50 (see FIGS. 3 and 4) and weakened zones 52 formed in the walls 42, 44 at frame corner locations. The notches 50 extend into the walls 42, 44 from the respective lateral wall edges. The lateral walls 42, 44 extend continuously along the frame structure 16 from one end to the other. The walls 42, 44 are weakened at the corner locations because the notches reduce the amount of lateral wall 40 material and eliminate the need for stiffening flanges 46. Advantageously, the walls 42, 44 are stamped to weaken them at the corners, which aids in the case of bending the spacer frame structure 16 into its polygonal shape.

The connecting structure 34 secures the opposite frame ends 62, 64 together when the frame has been bent to its final configuration. The illustrated example embodiment of FIG. 16, the connecting structure 34 comprises a connecting tab structure 66 continuous with and projecting from the frame structure end 62 and a tab receiving structure 70 at the other frame end 64. The preferred tab and tab receiving structures or spacer end 66, 70, respectively are constructed and sized relative to each other to form a telescopic joint 72, see FIG. 16. When assembled, the telescopic joint 72 maintains the frame in its final polygonal configuration prior to assembly of the unit 10.

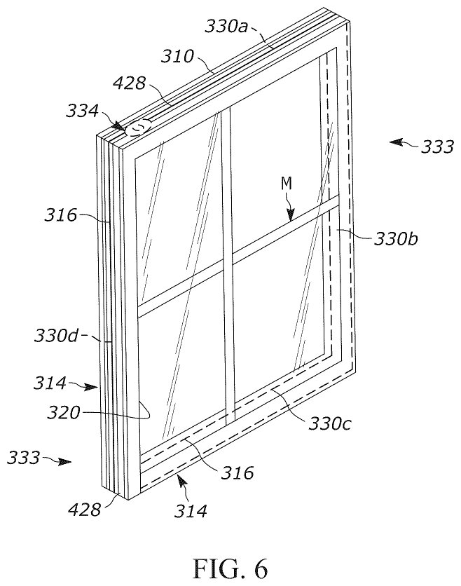

In the illustrated embodiment of FIG. 16, the connector structure 34 further comprises a fastener arrangement 85 for both connecting the opposite frame ends 62, 64 together and providing a temporary vent for the space 20 while the unit 10 is being fabricated. The illustrated fastener arrangement (see FIGS. 3 and 6) is formed by connector holes 84, 82 located, respectively, in the tab 66 and the frame end 64, and a rivet 86 extending through the connector holes 82, 84 for clinching the tab 66 and frame end 64 together. The connector holes 82, 84 are aligned when the frame ends 62, 64 are properly telescoped together and provide a gas passage before the rivet 86 is installed.

In some circumstances it may be desirable to provide two gas passages in the unit 10 so the inert gas flooding the space 20 can flow into the space 20 through one passage displacing residual air from the space through the second passage. The sealant body 18 and the desiccant body 22 each defines an opening surrounding the holes 82, 84, so that air venting from the space 20 is not impeded. The fastener 86 is installed at the same time and each is covered with sealant material so that the seal provided by each fastener 86 is augmented by the sealant material.

Further discussion of the metal spacer frame 16 construction and design is discussed and illustrated in U.S. Pat. No. 11,028,638 that issued on Jun. 8, 2021 and U.S. Pat. No. 5,295,292 that issued Mar. 22, 1994. U.S. Pat. Nos. 11,028,638 and 5,295,292 are incorporated in their entireties by reference for all purposes.

### The Insulating Glass Unit Using A Composite Spacer Frame

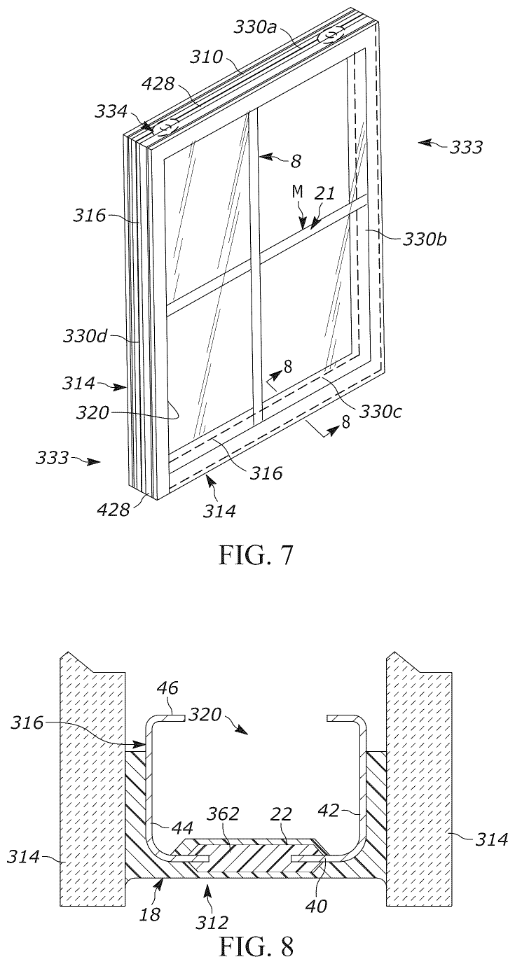

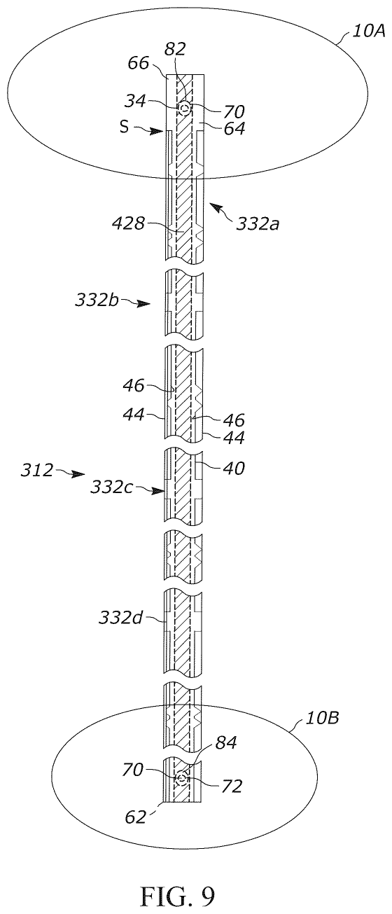

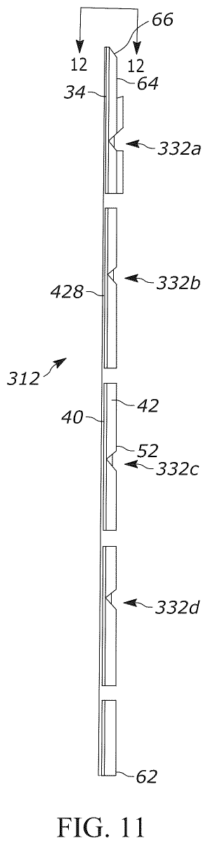

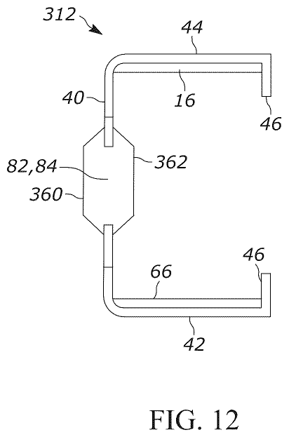

An insulating glass unit (IGU) 333 in FIG. 6 constructed using a composite spacer frame 316 formed of a metal and a polymer as illustrated in FIGS. 6-16 in accordance with methods and machinery of the present disclosure. Further details of the composite or thermal spacer frame 316 and its construction are described in U.S. Patent Publication US2021/0140228 entitled THERMALLY EFFICIENT WINDOW FRAME that published on May 13, 2021 (the “'228 Publication”), which is owned by the assignee of the present disclosure. The '228 Publication is incorporated herein by reference in its entirety.

The insulating glass unit (IGU) 333 is illustrated in FIG. 6, and includes the composite spacer assembly 310 sandwiched between glass sheets, or lites 314. The IGU 333 comprises a composite spacer frame 316 and sealant material (omitted for clarity) for hermetically joining the spacer to the lites 314 to form a closed space 320 within the IGU. The IGU 333 is illustrated in FIG. 6 is ready for the application of sealant around the perimeter of the spacer composite spacer frame 316 and upon completion in condition for final assembly into a window or door frame, not illustrated, for ultimate installation in a home or a building.

The IGU 333 as illustrated in FIG. 6 includes muntin bars “M” that provide the appearance of individual windowpanes. It would be appreciated by one having ordinary skill in the art that multi-pane IGUs were contemplated, and the frame structures used therein would be substantially the same as the composite spacer frame 316 described with regard to the IGU 333.

Further discussion of multi-pane IGUs and their assembly process is found in U.S. Pat. Nos. 9,416,583 and 9,534,439, which are assigned to the assignee of the present disclosure. Both U.S. Pat. Nos. 9,416,583 and 9,534,439 are incorporated herein in their entireties for all purposes.

The composite spacer frame 316 and a sealant body (not shown) co-act in a similar way as the metal spacer frame 12 to provide a structure which maintains the lites 314 properly assembled with the space 320. The space 320 is sealed from atmospheric moisture over long time periods during which, the IGU 333 is subjected to frequent significant thermal stresses. A desiccant (not shown) removes water vapor from air, or other volatiles, entrapped in the space 320 during construction of the IGU 333.

The sealant body both structurally adheres the lites 314 to the composite spacer frame 310 and hermetically closes the space 320 against infiltration of airborne water vapor from the atmosphere surrounding the spacer frame. The sealant is formed from a “hot melt” material which is attached to the frame sides and outer periphery to form a U-shaped cross section, similar to the metal spacer frame 12 and sealant illustrated in FIG. 2.

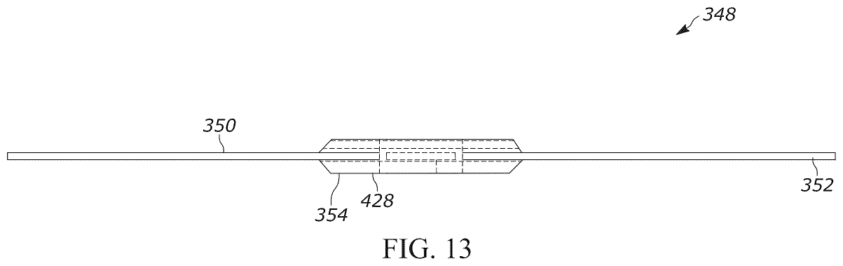

The composite spacer frame 316 extends about the unit periphery to provide a structurally strong, stable spacer for maintaining the lites 314 aligned and spaced while minimizing heat conduction between the lites via the frame. Illustrated in FIG. 13 is an end view of the continuous composite ribbon or flat stock 348 having a thermal barrier 354 before it is roll formed into a composite spacer frame 310. The composite ribbon or flat stock 348 includes a first metal section 350 and a second metal section 352 spaced by a thermal barrier 354. In one example embodiment, the thermal barrier 354 is a non-metallic material. In another example embodiment, the thermal barrier 354 is a polymeric material. In another example embodiment, the thermal barrier 354 could include an addition of a film or tape applied on one or both sides of the composite ribbon 348 extending along a portion of the first metal section 350, the entire thermal barrier 354 onto a portion of the second metal section 352.

Prior to a roll forming operation, the composite flat stock 348 is passed through a stamping station where the first and second metal sections 350, 352 are punched by a number of dies to form notches and weakening zones for corner folds, a connecting structure, a tab, gas fill apertures, and an end cut, similar to what is performed and shown on the metal spacer 12 in FIGS. 3 and 4. The thermal spacer frame 316 is initially formed as a continuous straight channel constructed from the thermal ribbon 348 comprising independent first and second metal sections 350, 352 formed from, for example, stainless steel having a thickness of approximately 0.006-0.010 inches linked via the thermal interruption strip 354, and in one example embodiment at least partially overlaid with the film (not shown). It should be appreciated that the metal stock 350, 352 could also be 1020 steel, mild steel, hardened steel, aluminum, CrMo steel, nickel, carbon steel, and the like.

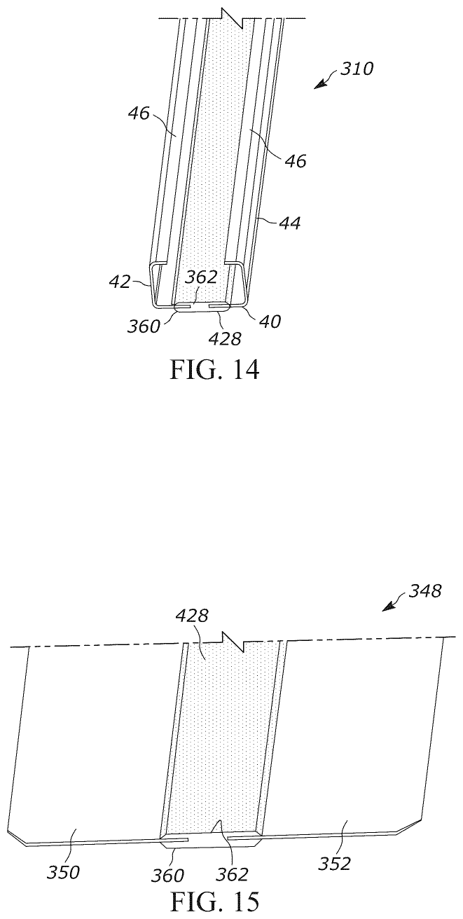

Once roll formed, the composite ribbon 348 results in a u-shaped channel cross section throughout the composite spacer frame 310, as illustrated in the example embodiment of FIG. 14. Defining the u-shaped channel cross section of the composite spacer frame 310 is a peripheral wall 40 and first and second lateral walls 42, 44. Note that the thermal barrier 354 is located in and projects from both sides of the peripheral wall 40 (unlike the metal spacer frame 12, illustrated in FIGS. 2-5). An exterior projection 360 and an interior projection 362 are part of and extend from the thermal barrier 354 as shown in FIGS. 14 and 15. These projections 360, 362 must be accounted for when constructing the composite spacer frame 310 on the same equipment and methodology as the metal spacer frame 12, as will be further described below in detail.

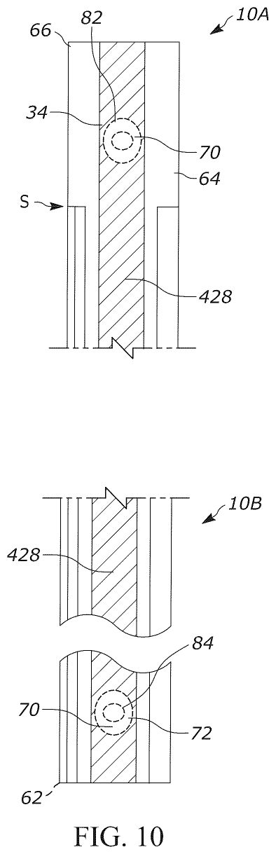

Once the u-shaped channel of the composite spacer frame 310 is formed (see FIG. 8), the spacer is cut, bent, and connected in a similar fashion as the metal spacer frame 12 illustrated in FIG. 10. That is, the spacer composite spacer frame 310 (that can also be illustrated in FIG. 10) includes a connecting structure 34, that secures the opposite frame ends 62, 64 together when the frame has been bent to its final configuration.

The composite spacer frame 310 before assembly (see FIG. 14) when folded together as shown in FIG. 16 also includes the connecting structure 34 comprising a connecting tab structure 66 continuous with and projecting from the frame structure end 64 and a tab receiving structure 70 at the other frame end 62. In the illustrated example embodiment of FIG. 16, tab and tab receiving structures 66, 70 are constructed and sized relative to each other to form a telescopic joint 72. When assembled, the telescopic joint 72 forming a telescopic connection TC maintains the frame in its final polygonal configuration prior to assembly of the composite IGU 333.

There are several different telescopic joints that have been formed with single metal spacer frames as invented by the applicant of the subject disclosure, such as U.S. Pat. No. 10,267,083 entitled TACTILE SPACER FRAME ASSEMBLY AND LOCKING MEMBER that issued on Apr. 23, 2019 (hereinafter “the '083 patent”), U.S. Pat. No. 12,134,931 entitled SPACER FRAME WITH RISING LOCKING MEMBER that issued on Nov. 5, 2024 (hereinafter “the '931 patent”), and U.S. Pat. No. 9,428,953 entitled SPACER FRAME AND METHOD OF MAKING SAME that issued on Aug. 30, 2016 (hereinafter “the '953 patent”). The '083, '931, '953 patents are incorporated herein by reference in their entireties for all purposes.

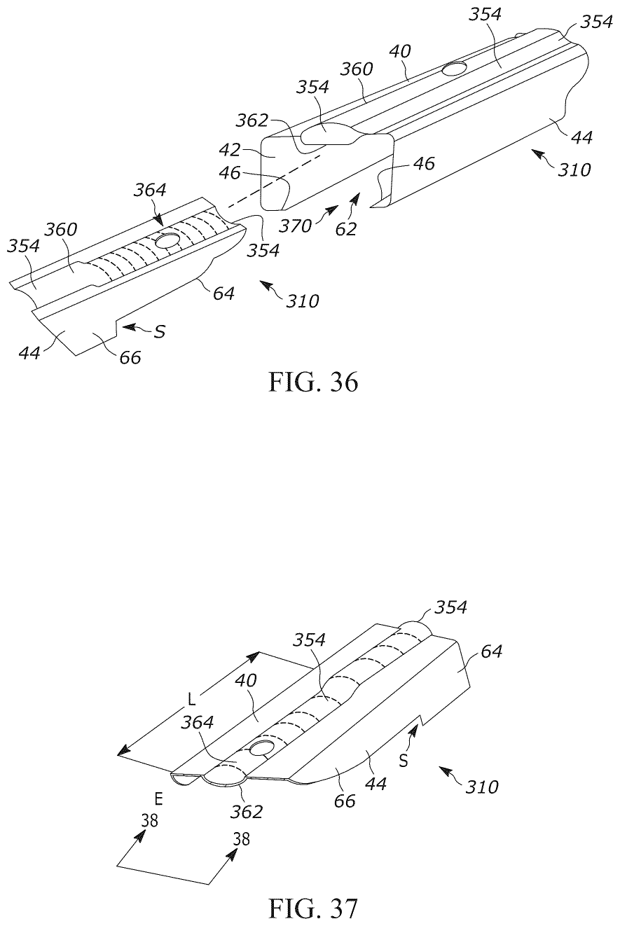

However, as shown in FIGS. 36 and 37, when the tab end 64 is inserted into the opening 370 of the spacer end 62 of the spacer frame 310 forming a closed frame, unlike the metal spacer frame 12, the thermal spacer frame 316 needs to account for the internal and external projections, 362, 360, respectively, of thermal barrier 354. That is, without further processing of the tab 64, the thermal barrier 354 would prevent the tab insertion into the opening 370 of the tab. As such, the example embodiments of FIGS. 36 and 37 further illustrate how the thermal spacer 316 has a recess or trough 364 that is formed during a swaging operation along a portion L of the exterior peripheral wall 40. In the example embodiment of FIG. 37, the trough or partial ellipsoidal void 364 along the peripheral wall 40 is the length L, which is at least as long as the length of the tab 64 from its end E to a stop S. In one example embodiment, the trough or partial ellipsoidal has a depth of 0.8 mm+/−. 1 mm.

The stop S engages the stiffening flanges 46 of the spacer end 62 in order to prevent further travel of the tab 64 into the space 370. The channel 364 allows for a sliding engagement with the interior projection 362 of the spacer end 62 and engagement by the tab 64 to form the telescopic connection TC.

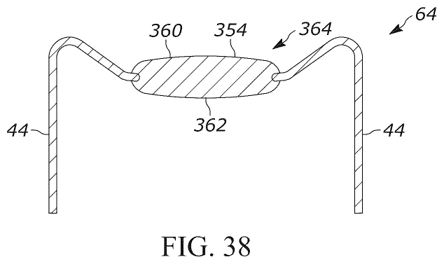

In the illustrated example embodiment of FIG. 38, the formed channel formed in the peripheral wall 40 of the tab 64 is recessed to form a W-shaped channel 364 to provide some resistance from the tab and spacer end from unlatching once the telescopic connection TC is made as illustrated in FIG. 16. The telescopic connection TC of the W-shaped channel portion 364 also advantageously provides an enhanced seal between the fifth leg connecting structure 34 and spacer end 62.

The structural elements of the multi-composite thermal spacer frame 310 are produced by the method and apparatus of the present disclosure. Further discussion of the multi-composite spacer frame construction and design is discussed and illustrated in U.S. Patent Publication Number 2021/0140228 that published on May 13, 2021. U.S. Publication 2021/0140228 is incorporated in its entirety by reference for all purposes.

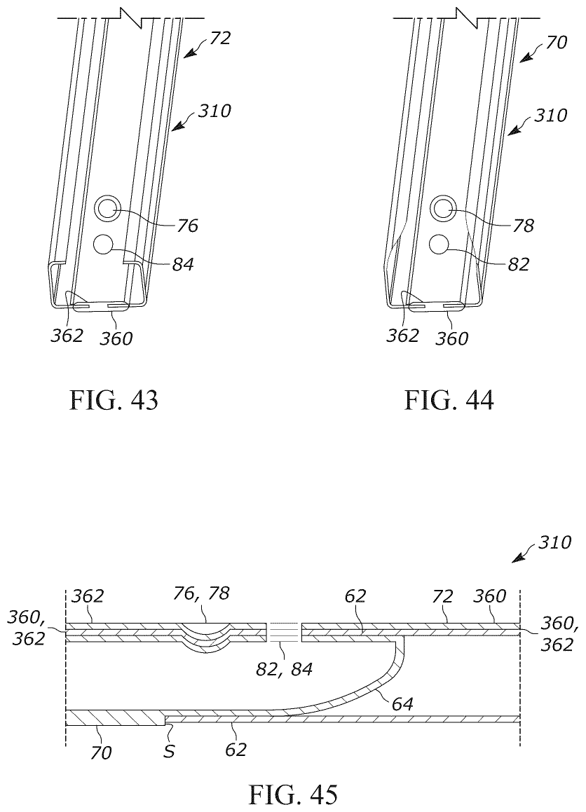

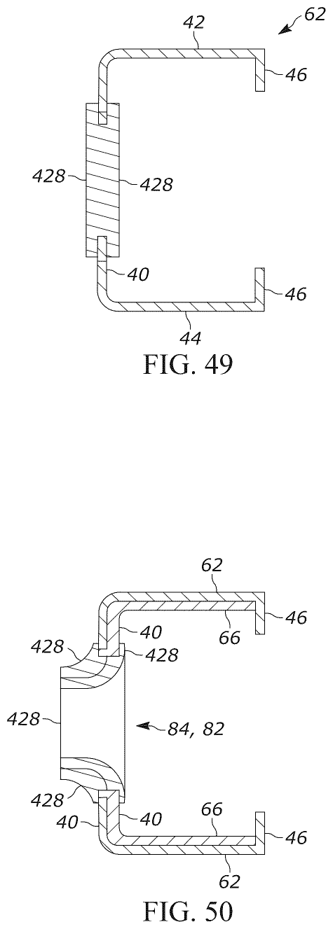

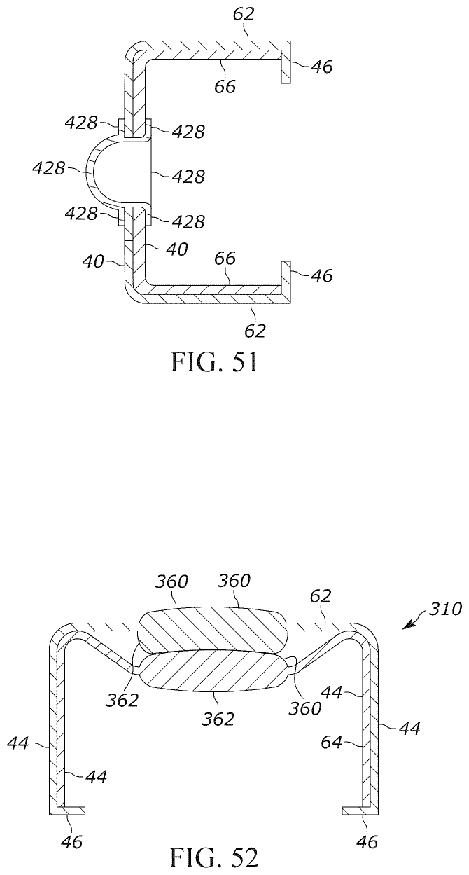

FIGS. 43-51 illustrate a number of embodiments in which a thermal spacer frame is configured and designed in accordance with the present disclosure. FIGS. 43 and 44 illustrate in accordance with one example embodiment thermal spacer frame end members that form a telescopic connection 72 as illustrated in FIG. 45. Within the thermal barrier 354, a dome 76, 78 is formed in the respective end member that locks the telescopic connection 72 together and aligns apertures 82, 84 between members as illustrated in FIGS. 45 and 16. In one example embodiment, the thermal barrier 354 is formed from a polymeric material having a thickness of approximately. 7 mm spacing a gap across a polymer bridge of approximately 3 mm. Of course it would be appreciate by those of ordinary skill in the art having reviewed the drawings and specification of the present disclosure to understand greater and smaller dimensions across the thermal bridge and its thicknesses are within the spirit and scope of the claimed invention(s).

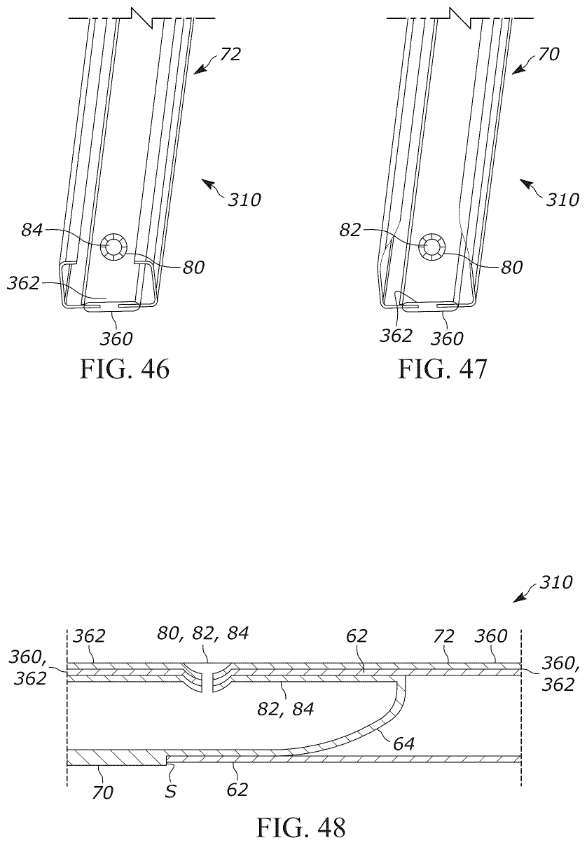

FIGS. 46 and 47 illustrate in accordance with one example embodiment thermal spacer frame end members that form a telescopic connection 72 as illustrated in FIG. 48. Within the thermal barrier 354, conical drops 82, 84 that lead to a respective aperture 80 formed in the respective end member that locks the telescopic connection 72 together and aligns apertures 80 between members as illustrated in FIGS. 45 and 16. Stated another way, conical drop in each member nest with each other to prevent the end members from separating from the joint 72 once combined.

### The Production Line 400

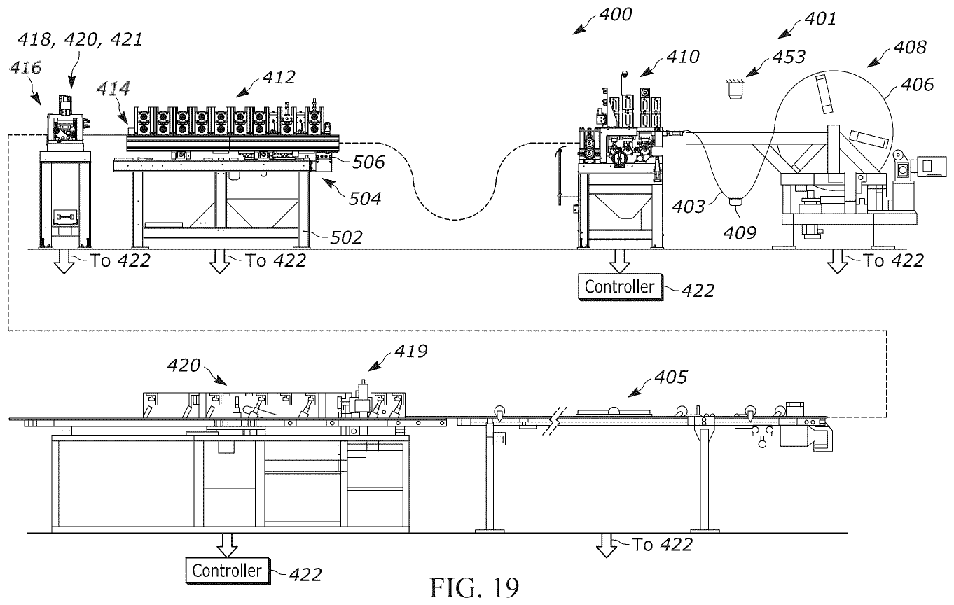

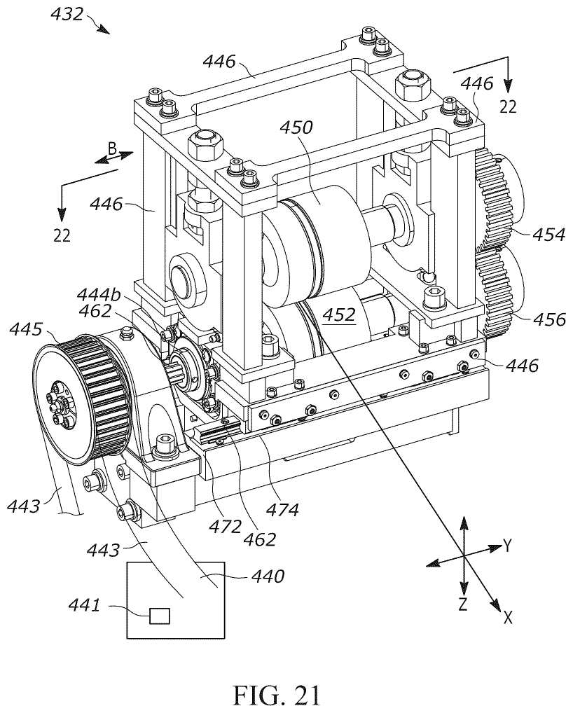

An operation, method, and process 401 by which elongated window components, and in particular spacer frames are made is schematically illustrated in the example embodiment of FIG. 19 as a production line 400. A strip 403, whether fully metal or a composite 348 is uncoiled at the beginning of the process 401 at a supply or uncoiling station 408. The strip 403 can include a thermal sheet stock 348, comprising the two thin, relatively narrow ribbons of sheet metal stock 350 and 352 linked by the thermal interruption strip 354, as illustrated in FIGS. 21-23. In another example embodiment, film or tape (not shown) is added over the thermal barrier 354 and a portion of the first and second metal sections 350, 352 as illustrated in FIGS. 21-23. Alternatively, the strip 403 is a purely metal strip of stainless steel, carbon steel, a coated steel, or any combination thereof.

The strip 403 is fed endwise from a coil 406 on the uncoiling station 408 into one end of the assembly line 400 and a substantially completed elongated window components for a spacer frame (whether a thermal spacer frame 316 or metal spacer frame 16, collectively hereinafter “spacer frame 402”) emerges from the other end of the line.

The assembly line 400 comprises a stock supply station 408, a line balancer 409, a first forming station or feeder press 410, a second forming station or roll former 412, a crimping station 414 (located between the crimping station and swaging station), a splay forming station 416, and a swaging station 418. Within the assembly line 400, partially formed spacer assemblies 402 are separated from the leading end of the thermal sheet stock or metal sheet stock 403. The sheet stock 403 is roll formed in the roll forming station 412, and subsequently the spacer frame 402 corner locations are deformed by the crimping station 414, allowing the corners of the spacer 402 to be easily bent and formed/connected in a polygonal shape such as the rectangle or square of FIG. 16. At a desiccant application station 419 desiccant is applied to an interior region of the spacer frame member 402 and at an extrusion station 420 sealant is applied to the yet to be folded spacer frame assembly 402.

A scheduler/motion controller unit 422 interacts with the stations (406, 408, 410, 412, 414, 416, 418 419, and 420) of the production line 400 and loop feed sensors (not shown) to govern the spacer type (thermal or metal), stock size, spacer assembly size, stock feeding speeds throughout the assembly line 400, and other parameters involved in production. Each station of the production line 400 further comprises a return loop for providing data back to the controller 422. An example controller unit 422 is commercially available from BR Automation and sold under model number B&R X20CP1584. In one embodiment a separate controller 422 controls the desiccant application and adhesive or sealant application. While yet in another example embodiment, any of the aforesaid stations have their own dedicated controller that communicates with the central controller 422. Additional details of a spacer frame fabrication system are contained in US Pat. Pub. No. 2006/0075719 to James et al., which is incorporated herein by reference.

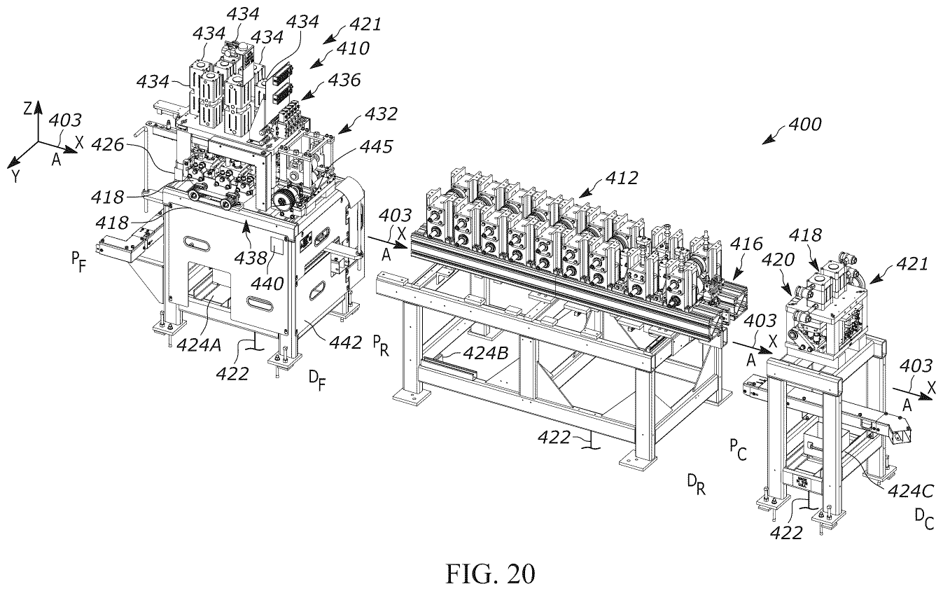

In the illustrated example embodiment of FIGS. 19 and 20, the stations 406, 408, 410, 412, 414, 416, 418, 419, and 420 take instructions from the controller 422 and provide feedback to the controller as to speed, stopping, errors, or malfunctions should such event occur in any of the stations. The controller 422 also includes a switch on the feeder press input to identify the type of strip 403 (metal 402 or thermal/composite) is being supplied to the assembly line 400. In another example embodiment, sensors are used to identify the type of strip 403 being supplied from the uncoiling stations as to whether a thermal/composite or metal spacer 402 is being manufactured. In the current example embodiment, as the type of spacer frame 402 changes from composite to metal or metal to composite, the controller 422 instructs one or more stations to make automatic changes to accommodate the different types of material required in the strip. For example, and as further described below, when manufacturing metal spacer frames and then changing over to composite spacer frames or the converse, the feeder press station 410, roll forming station 412, and swaging station 418 are enabled and/or makes an automated shift in tooling to accommodate the different types of material in the strip 403. In one example embodiment, the type of material in the strip is manually entered by a switch at the feeder press into the controller 422 and the production line stations adjust accordingly for the material type (thermal/composite or metal). In another example embodiment, the controller 422 includes a barcode reader that reads a signature code, barcode, 2D barcode, RC code, and the like to read from the coil of material and the controller 422 and the production line stations adjust accordingly for the material type (thermal or metal). While in another example embodiment, the type of material in the strip is detected and read by a material sensor and provides a signal to the controller 422 and the production line stations adjust accordingly for the material type (thermal or metal).

### Forming Stations of the Production Line 400

Illustrated in FIG. 20 are three forming stations 410, 412, and 416/418 of the production line 400 in a perspective view used for changing spacer strips 403 for manufacturing both the metal spacer frame and composite spacer frame, collectively 402, as described above. Each of the forming stations 410-418 are in communication with the controller 422 and a shared or individual encoder 424 that monitors the feed rate of the strip 403 through each station in the direction of arrows A. The strip 403 translates through each forming stations 410, 412, 416, and 418 along a central axis X that defines a fixed flow path of the material through the forming stations 410-418. The strip 403 enters the forming stations 410-418 along the central axis X at a proximal end “P” of each station and exits at the distal end “D” of each station.

The forming stations accommodate, as further described below, the two different types of stock strip 403, a full metal stock strip 403A and a composite stock strip 403B formed from both metal and a non-metal thermal barrier to form a metal spacer or composite spacer 402.

To achieve fabrication of both spacer types on the forming stations, the feeder press station 410, roll forming station 412, and swaging station 418 are two-tooled to make changes at the station, either manually by an operator, or automatically through instructions provided by the controller 422 to each station 410, 412, and 418. In the illustrated example embodiment of FIG. 20, instructions as to the type of strip, 403A or 403B, are determined by a selection switch elected by an operator located on the assembly line 400 to inform the controller 422 (or schedule from a CPU/controller 422) and stations to make a change over if necessary. In another example embodiment, a signal is received by a sensor 426 positioned at the front of the production line 400, such as at the uncoiler station 408 or feeder press 410 to force the changeover from the controller 422 to each station.

The sensor 426 checks for the presence of metal or the absence of metal and could be for example, a vision system that measures contrast of the strip 403, capacitive sensor, hall effect sensor, light curtain to measure the geometric shape of the strip, magnetism detecting sensor, or any combination thereof. Once the sensor 426 detects the type of strip 403A or 403B, the feed roller station 410 and roll forming station 412 shift the tooling relative to the central axis X as needed to accommodate the different type of strips 403A, 403B. The sensor 426, upon detecting the type of strip to be entirely metal 403A, disables the finishing station 418 and allows the material to simply pass after processing from the crimping operation 414 into the swaging station 418 but without any processing of the swaging stations. If the sensor 426 detects a composite/thermal barrier type strip 403B, it will enable the swaging station upon receipt of the composite stock strip 403B so that processing at the finish station 418 occurs by swaging the spacer frame 403. In yet another example embodiment, a shift of the tooling in stations 410 and 412 relative to the central axis X is based on communications to each station by a scanned product code and/or schedule in which the strips 403A or 403B are being processed.

The composite strip 403B includes thermal interruption barrier 354 that projects outwardly and inwardly from the peripheral wall 40 to a form an elongated bead 428 at least partially within flat metal stock 403B along the peripheral wall 40. In yet another example embodiment, the tooling in the forming stations 410 and 412 are constructed to manufacture spacer frame assemblies, requiring movement of tooling relative to the central axis X (material flow path) when changing between the flat metal strip 403A and composite strip 403B. In another example embodiment, the flat metal strip 403A passes through the forming stations 410 and 412 with the same tooling on the forming stations if the metal spacer 403A peripheral wall 40 is larger than the peripheral wall 40 of composite spacer 403B.

### First Forming Station Feeder Press 410

FIGS. 20-25 illustrate an example embodiment of a first forming station comprising a feeder press 410. The feeder press 410 includes a stand 430 in which a feeder assembly 432 is mounted. The strip 403 translates through the feeder press 410 along a central axis X that defines the fixed flow path of the material through the forming stations 410, 412, 414, 416, and 418. The strip 403 enters the forming stations along the central processing axis X at a proximal end “P” of each station and exits at the distal end “D” of each station.

The feeder press 410 also includes, in the illustrated example embodiment, the sensor 426 for detecting the type of strip 403 and the feeder press 410 makes an automatic change-over if the material type of the strip entering the press is different from the prior strip material exiting the press. Instructions are provided by the controller 422 to the station 410 so that changes in material strip 403 types, for example, 403A to 403B or 403B to 403A, are communicated to the press station so that sensors enable actuators to move tooling for an automated change-over.

One function of the feeder press 410 is to advance the strip 403 material through the assembly line 400 by pinching the strip between two rollers, one being a motor driven roller, and the other an idle roller. The feeder press 410 also operates to measure (by for example, with an encoder) the end length of the spacer 403 used for down production line 400 cutting of the proper overall length of the finished spacer 402. The feeder press 410 also measures and provides punched notches for corners of the finished spacer, notches for muntin keys and/or muntin bars, measures and provides gas apertures in the finished spacer, and measures for punching, special geometry notching in the front or tab or spacer end of the finished spacer. The punching operation of the feeder press 410 is located at a proximal end Pr of the station and is achieved by a number of pneumatic cylinders 434, sensors 436, and punch dies 438 that are actuated by the controller 422. With the feeder press 410, the thermal sheet stock strip 403B and metal stock strip 403A are punched for any indentations or openings needed, including a marking for a cutoff or scrap piece, so that the formation and length of the spacer 403 is correct for finishing.

The feeder press 410 operates to apply the necessary torque to the strip 403 and regulate the necessary feed rate of the strip throughout the production line 400. The feeder press 410 includes a feeder assembly 432 fixed at the distal end Dr of the stand 430 and controls the torque and feed rate of the strip 403 as instructed by the controller 422. FIG. 21 illustrates the feeder assembly 432 in accordance with one example embodiment that comprises a drive motor 440 located in a sound enclosure 442 within the stand 430. The motor 440 includes a pinion gear 441 that engages and rotates a drive gear 445 where the drive gear is mounted to a drive shaft 444. In the illustrated example embodiment, the drive motor 440 is located in the enclosure and includes a pinion wheel surrounded by a belt 443 that rotates a drive gear 445 that rotates the drive shaft 444.

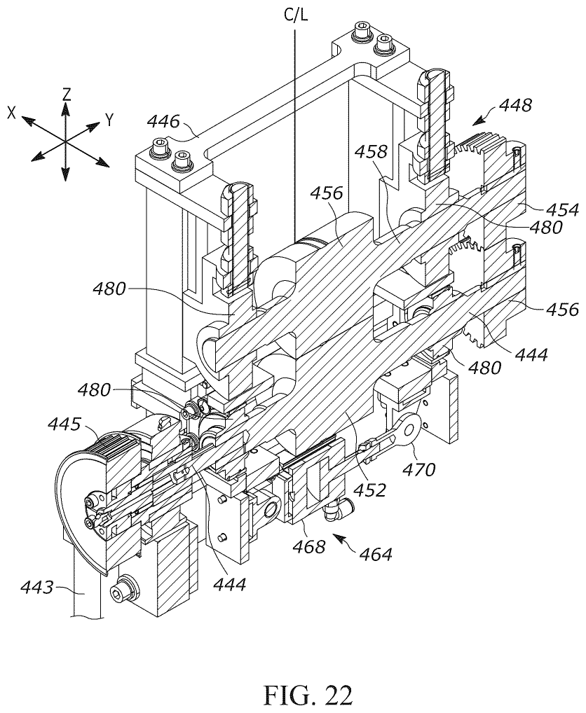

The feeder press 410 includes, within the feeder assembly 432, a shuttle arrangement 448, as shown in FIGS. 21 and 22, and further includes upper and lower pinch rollers 450, 452, respectively, upper and lower feed gears 454, 456, respectively, a fixture arrangement 446, an advancement assembly 464 that includes a cylinder 468 and adjustable cylinder end 470, and slides 462 from which the shuttle arrangement 448 is mounted. The shuttle arrangement 448 is translated transversely to the central process axis X, depending on the type of strip stock 403 being manufactured into a spacer frame as further described below.

In this example embodiment of the present disclosure, the feeder press 410 is configured to accept spacer strip material with or without a thermal barrier. The feeder press 410 utilizes the upper and lower pinch rollers, 450, 452, which pull the strip 403 through punch dies 418 regardless of the type of strip 403A or 403B.

Prior to entry in the feeder press 410, the thermal sheet stock 403B and metal sheet stock 403A are indexed and sorted in the stock supply station 408. The stock supply station or uncoiler 408 is further described in U.S. Pat. No. 7,445,682 B2 to James et al., which is incorporated by reference herein for all purposes. In the stock supply station 408, a drive mechanism controlled by the controller 422 uncoils a roll of thermal stock 403B and metal stock 403A.

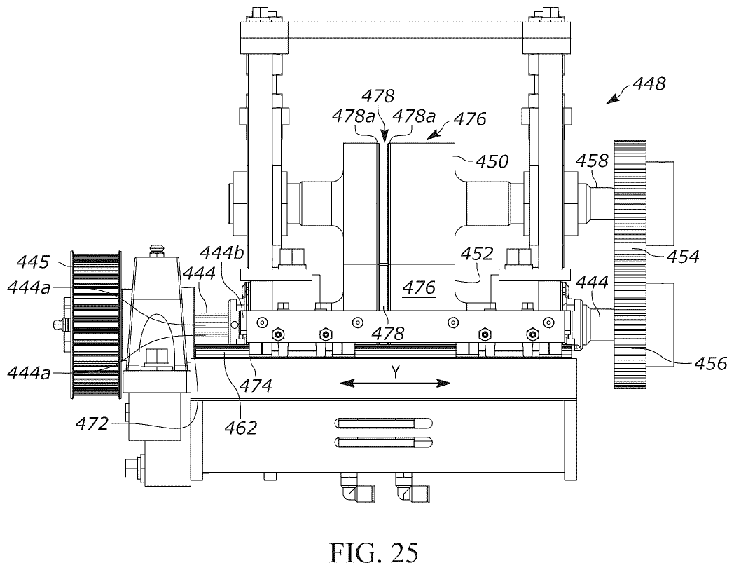

FIG. 22 shows a cross sectional view of FIG. 21, which illustrates the feeder press 410 along section lines 22-22 in FIG. 21. The upper 450 and lower 452 pinch rollers are configured to form first 472 and second 474 positions (see FIG. 25) in which different types of spacer strips 403 are accommodated. In one example embodiment of the present disclosure, a standard spacer strip comprises a first spacer strip type 403A, while a thermally efficient spacer strip comprises a second spacer strip type 403B. One of ordinary skill in the art, after reviewing the contents of the present disclosure, would understand that the feeder press 410 could be adjusted to accommodate a variety of spacer strips 403 of differing dimensions and configurations. In one example embodiment of the present disclosure, the first spacer strip type 403A comprises a flat strip, while the second spacer strip type 403B comprises a strip having an elongated bead 428 about the center of the metal strip. In another example embodiment of the present disclosure, the first spacer strip type 403A comprises a strip having a width range of 0.888″-1.600″ inches while the second spacer strip type 403B has a width range of 0.888″-1.600″ inches. Of course, it should be appreciated by one of ordinary skill in the art with the advantage of the current specification and drawings to understand that the equipment could be reconfigured to accommodate smaller and larger width ranges without departing from the spirit and scope of the present disclosure and associated claims.

In one example embodiment of the present disclosure, the pinch rollers 450, 452 of the feeder press 410 comprise a smooth annular portion 476 and a grooved annular portion 478, wherein the smooth portions accommodate a first type of spacer strip 403A, and the grooved portions accommodate the bead 428 of the second thermal interruption type of spacer strip 403B. In particular, the groove annular portion 478 provides spatial relief for the thermal barrier 354, including the external projection 360 and the internal projection 362. Advantageously, the pinch rollers 450, 452 having smooth 430 and grooved 432 portions allows the pinch rollers to accommodate substantially flat 403A and curvilinear spacer strips 403B.

The feeder press 410 is programmable and instructed by the controller 422 to mechanically shift or translate the positioning of the shuttle arrangement 448 from the first 472 to the second 474 position (actuated by cylinder 468) such that the proper portion (476 or 478) is in alignment with the central axis in which strip 403 is fed. Stated another way, if the controller 422 instructs the feeder press 410 to process a thermal strip 403B, the cylinder 468 is actuated to pull the feeder assembly 432 along slides 462 such that the grooved portions 478 are axially aligned with the central processing axis X, the axis defining the flow of material. The thermal projections 360 and 362 then ride in the groove 478 while the strip 403B is being pulled.

Upon receiving instructions that the material in the strip 403 is changing from 403B to 403A, the controller 422 instructs the cylinder to actuate such that the annular groove portions 478 are translated away from the central axis X about which the material flow is processed. During translation, the entire feeder assembly is translated along slides 462 until the smooth annular portion 476 of the pinch rollers 450, 452 are located about the flow of material process axis X.

The lower, second, or drive pinch roller 452 is fixedly attached to drive shaft 444, which in the illustrated example embodiment (see FIG. 22) is a spline shaft 444 that includes multiple splines 444a. The plurality of splines 444a allow torque to be transmitted from the drive gear 445 to the pinch rollers 450, 452 as well as allowing for the movement of the shuttle arrangement 448 to move from the first 472 and second 474 positions as directed by the controller 422 for the type of strip 403 being processed. The concomitant rotation of the pinch rollers 450, 452 is synchronized by upper and lower feed gears 454, 456, respectively, which are rotated at the same speed as the drive shaft 444 based on the rotational speed of the drive gear 445 from the belt 443 and motor 440.

The advancement assembly 464 located at the bottom of the feeder assembly 432 translates the shuttle arrangement 448 between first 472 and second 474 positions. In one example embodiment of the present disclosure, an actuator 468 of advancement assembly 464 comprises a pneumatic cylinder. Upon command by the controller 422, an instruction is sent to a local controller and/or valve to energize and shift the cylinder 468 from one position to the other position by advancing or retracting the piston within the cylinder. One of ordinary skill in the art, after reviewing the contents of the present disclosure and figures, would understand that a variety of actuators 468 would be compatible with the feeder press assembly 410 of the present disclosure.

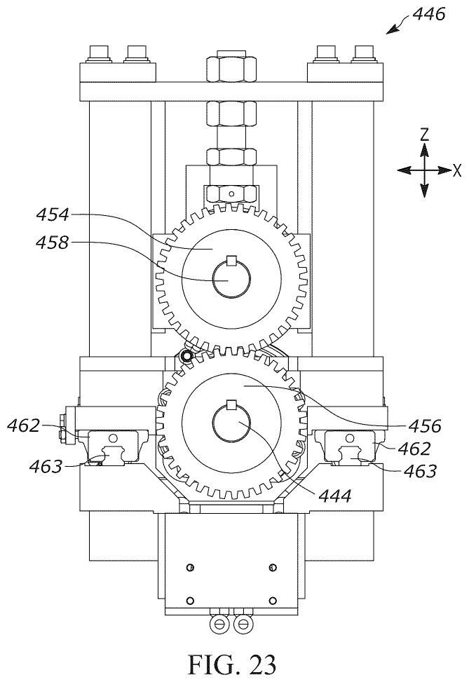

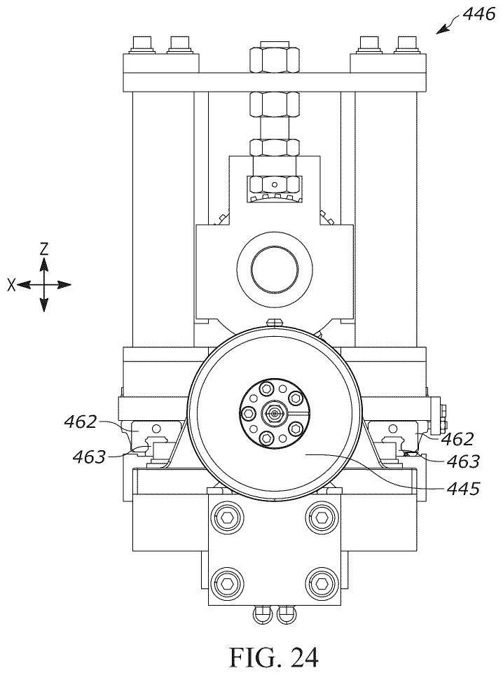

FIGS. 23 and 24 illustrate a side view of the feeder press assembly 410 having pinch rollers 450 and 452 in accordance with one example embodiment of the present disclosure. Gears 454, 456 and slide bearings 480 work together to shift the shuttle arrangement 448 between the first 472 and second 474 positions when the actuator 468 is energized as the shuttle arrangement 448 translates along the slide 462 formed by the top rail and a bottom rail 463 acting as a linear bearing (see FIG. 23). In the illustrated example embodiment, the shuttle arrangement 448 further translates by the drive shaft 444 being formed of a two-piece shaft in which the first is formed by splines 444a and the second part being a corresponding female tubular splines 444b that moves about the spines 444a remaining engaged for the transmission of torque throughout the shifting of the shuttle arrangement from the first to second positions 472, 474 and second to the first positions 474, 472.

During operation, a command by the controller 422 in the form of one or more instructions are sent to a local controller to the feeder press 410 and/or valve to energize and shift the cylinder 468 from one position to the other position by advancing or retracting the piston within the cylinder. For example, an operator may enter the type of strip 403 being processed, a barcode is scanned, a sensor detects the strip type, or any combination thereof and the controller 422 instructs the shuttle arrangement 448 to move to a first position 472, so that the smooth portion 476 of the pinch rollers 450, 452 is about the central process axis X so that the metal strip 403A can be pulled and processed through the assembly line 400. When the material in the strip is changed to process a strip with a thermal barrier 403B, an operator may enter the type of strip 403B being processed, a barcode is scanned, a sensor detects the strip type, or any combination thereof and the controller 422 instructs the shuttle arrangement 448 to move to a second position 474, so that the recessed/grooved portion 478 of the pinch rollers 450, 452 is about the central axis X so that the thermal strip 403B can be pulled and processed through the assembly line 400.

FIG. 25 illustrates a front view of the feeder press assembly 410. This view highlights the grooved portions 478 of the pinch rollers 450, 452, which allow a second type of spacer strip 403B to pass through the assembly line 400 for further processing. In one example embodiment of the present disclosure, the depth of the grooves are approximately ten thousands of one inch 0.010″ to two thousands of one inch 0.002″ deep. In another example embodiment of the present disclosure, the second type of spacer strip is a spacer strip 403B having an elongated groove 478 for accommodating a thermal barrier 428, and the grooves of the pinch rollers 450, 452, allow the elongated groove 478 for a thermal barrier 428 to pass through the assembly 410 without being compromised or flattened. Stated another way, the grooved portions 478 of pinch rollers 450, 452, comprise crest portions 478a, and said crest portions 478a align with the elongated grooves 478 to maintain the shape of the spacer strip 403B.

Advantageously, the feeder press assembly 410 improves efficiency and reduces the amount of equipment needed for the construction of multiple types of spacer frames due to the pinch rollers 450, 452, having multiple surface types of smooth and grooved between which shifting or tooling change-over occurs. In one example embodiment, the shifting between first and second positions 472 and 474 occurs automatically. In another example embodiment, the shifting between first and second modes 472 and 474 occurs manually based on user input. In another example embodiment, the feeder press assembly 410 further comprises a sensor 426, which comprises an eye or window in one example embodiment of the present disclosure used to scan the strip 403 or to sense the type of strip. In yet another example embodiment, the sensor 426 comprises a capacitive sensor which senses the presence of metal or lack of metal and signals to the controller 422 the type of strip 403 being processed, which is used by instructions in the controller whether a shift in the shuttle assembly 448 is required. One of ordinary skill in the art, after reviewing the contents of the present specification and figures, would understand that a variety of sensors are included in the spirit and scope of the present disclosure. A schedule driven system can also be used to select the strip type, adjusting the system to run the strip 403A or 403B.

### Second Forming Station Roll Form Press 412

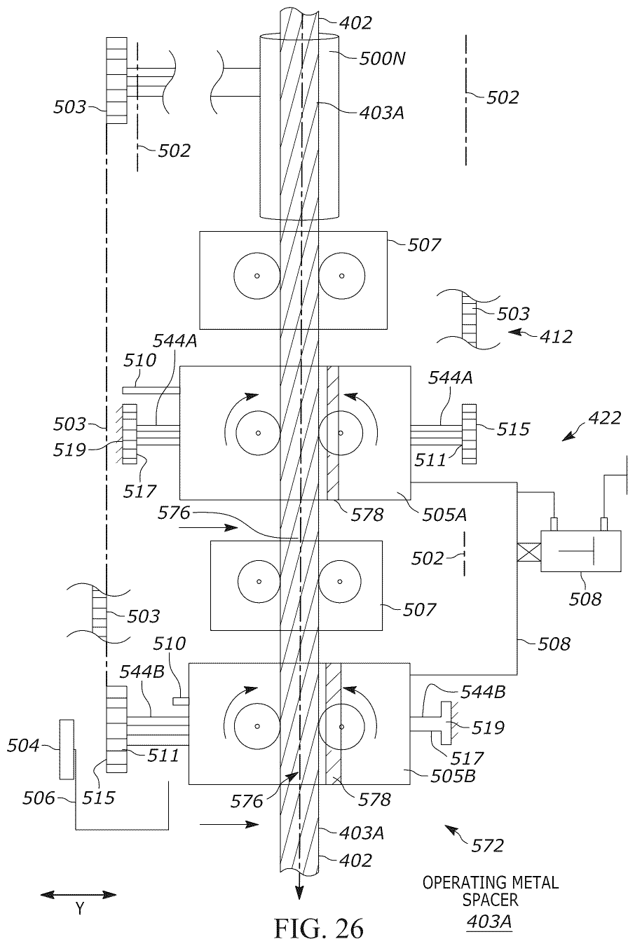

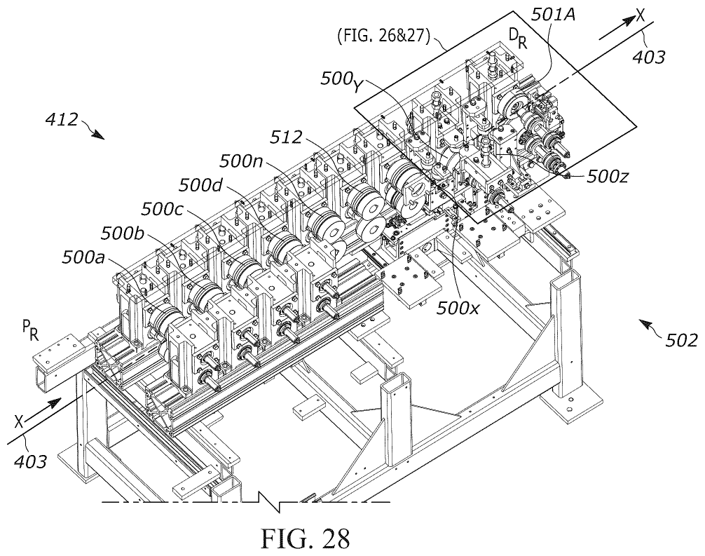

FIGS. 26-29 illustrate portions of a full roll form press assembly 412 constructed in accordance with one example embodiment of the present disclosure. The roll form press assembly 412 is responsible for roll-forming the spacer strip 403 to form a u-shaped channel by passing through a series of roll forming dies 500 (see FIG. 28). The roll form press assembly 412 features a frame structure 502, roll passes or dies 500, a roll assembly drive motor 504, a drive transmission 506, drive rollers 505, idle rollers 507, an actuating system 508, and shuttle arrangement 510 for enabling the assembly 412 to roll form stock having different types of strips 403, namely full metal strip 403A and thermal strip 403B.

In one example embodiment, the roll forming assembly 412 comprises first 500a, second 500b, third 500c, and fourth 500d roll passes of roll forming dies 500 through which the spacer strip 403 passes along the central axis X. One of ordinary skill in the art, after reviewing the contents of the present disclosure, would understand that a variety of numbers of roll passes 500n are compatible with the roll form assembly 412 and are included in the spirit and scope of the present disclosure. A belt or chain 503 is coupled to corresponding gears on each of the roll forming dies 500n and drive rollers 505. The belt/chains are coupled to a single motor and transmission so that the movement of material remains synchronized as it passes through the station 412. Further discussion of the operation of the roll forming operation is described in U.S. Pat. No. 5,295,292, which is incorporated herein by reference in its entirety for all purposes.

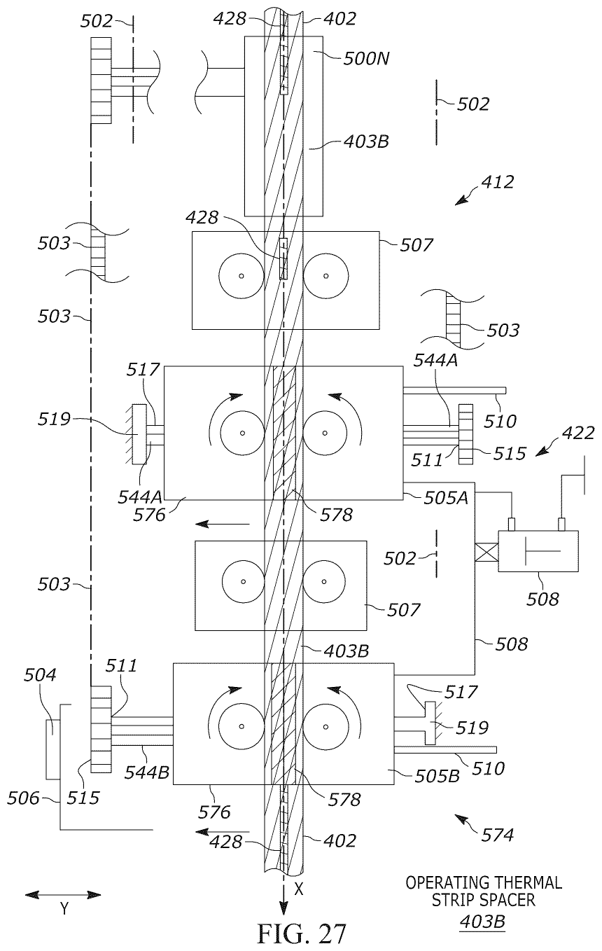

The drive transmission 506 includes a belt or chain 503 and pinion gear attached to the motor 504 (see FIG. 19) that engage all of the form rollers 500 and a pair of drive rollers 505 (see FIGS. 27 and 28) and drive shafts 544A and 544B that are in a male/female spline arrangement that allow for the continuous engagement and transmission of torque of the shafts during movement of the shuttle arrangement 548 within the drive rollers. In the illustrated example embodiment of FIGS. 26 and 27, the plan view illustrates that the chain or belt 503 is used on both sides of the form roller 412 and driven by the motor and transmission 506 so that all the rollers 500 and 505 remain in synchronized or concomitant rotation in forming the u-shaped spacer channel and driving the material through the station.

The drive shafts 544A and 544B are splined so that a shuttle 508 can translate the drive rollers 505A and 505B about the shafts 544 while maintaining a torque transmission connection as different materials used to form the spacer frame. At a first end 511 of the shafts 544, a drive gear 515 is coupled to the drive chain 503. At a second end 517 of the shafts 544, a stationary bearing 519 is coupled with a female splined opening to receive the shaft 505. Between the two ends, 511 and 517, the shafts 505 are fixed between the drive gear 515 and stationary bearing 519. However, the drive rollers 505 are selectively movable based on instructions from the controller 422 depending on the materials being used, 403A or 403B, to be formed by the station 412. The controller 422 sends instructions to the roll former station depending on the type of metal strip 403A, B being formed. When processing a metal spacer frame 403A, an instruction is sent to the roll former station such that the processed strip does not engage the grooved portion 578 of the drive rollers 505. That is, the drive rollers 505 are coupled to a slide 510 that is fixed to an actuator system 508 that includes, for example a cylinder with a valve that is energized to selectively translate first and second drive rollers 505 so that the process axis X for the processed material does not engage the groove portion 578 as illustrated in FIG. 26. Stated another way, the grooved portion 578 is located to a side of the material being processed.

Upon receiving information from a sensor or operator input identifying a change from a purely metal spacer 403A to a thermal spacer 403B, the controller 422 sends an instruction to the actuator system 508. The signal sent by the controller 422 enables the actuator system 508 to selectively translate the drive rollers 505 along the shafts 544 by activating an actuator 508 such as a valve/cylinder combination. The actuator system 508 then translates the slide 510 and coupled drive rollers 505 transversely (see arrows Y) to the direction of the material flow or process axis X. Because the slide 510 is coupled to the drive rollers 505, the translation of the slide repositions the groove portion 578 to be aligned with the processing axis X as illustrated in FIG. 27.

The roll form assembly 412 improves efficiency and reduces the amount of equipment needed for the construction of multiple types of spacer frames due to the drive rollers having multiple surface types 576, 578 between which shifting occurs. In one example embodiment, the shifting between first a first position 572 (see FIG. 26) and a second position 574 (see FIG. 27) occurs manually based on user input. In one example embodiment of the present disclosure, this shift between first 572 and second 574 spacer stock positions occurs automatically based on sensor 426/453 input. In this example embodiment, the roll form assembly 412 sensor 453/426 comprises an eye, capacitive sensor, hall effect sensor, or any combination thereof. One of ordinary skill in the art, after reviewing the contents of the present disclosure, would understand that a variety of sensor types are included in the spirit and scope of the present disclosure.

In one example embodiment of the present disclosure, if the sensor 453/426 detects that the spacer strip 403 is of the second variety 403B, tooling of the roll forming assembly 412 moves relative to the strip 403 that is laterally stationary as it moves longitudinally along the central axis X. Before the entry of the strip 403B into the roll forming machine 412, a shuttle arrangement 508 moves select drive rollers 505 such that smooth portion 576 is translated from the first position see FIG. 26 to the second position see FIG. 27 so that the bead 428 aligns with the grooved portion 578 of the drive rollers so the grooved portions entrap the spacer strip 403B and isolate the thermal break 428 so that the spacer strip 403B and thermal break 428 (partially shown in FIG. 27) remains intact.

### Third Forming Station Crimping Assembly 414

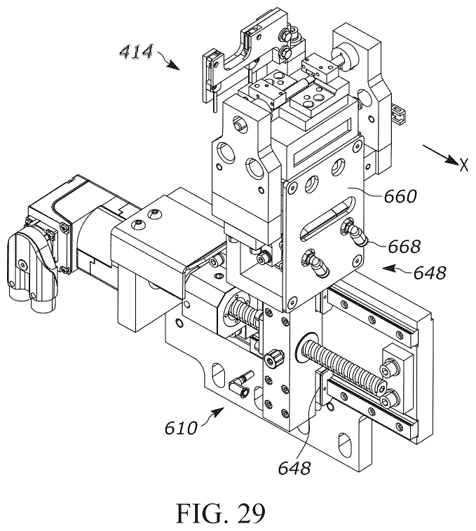

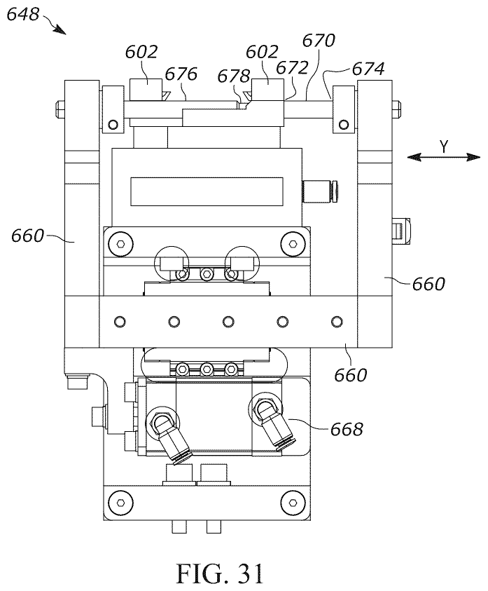

A crimper assembly 414, is shown in FIGS. 29-31. The crimper assembly 414, like the other parts of the assembly line 400, can switch between first 672 and second 674 positions transversely relative to the central axis X defined by the flow of material to be processed by the line in order to support first homogeneous metal spacer strip 403A and second thermal spacer strip having two different material types 403B. In one example embodiment, the transverse motion of the first and second positions, 672, 674, respectively is illustrated in FIG. 31 about an axis Y. Referring now to FIG. 29, the crimper assembly 414 is configured to support a spacer strip 403B that accommodates a thermal barrier, as well as, full metal spacer 403A that has been roll formed.

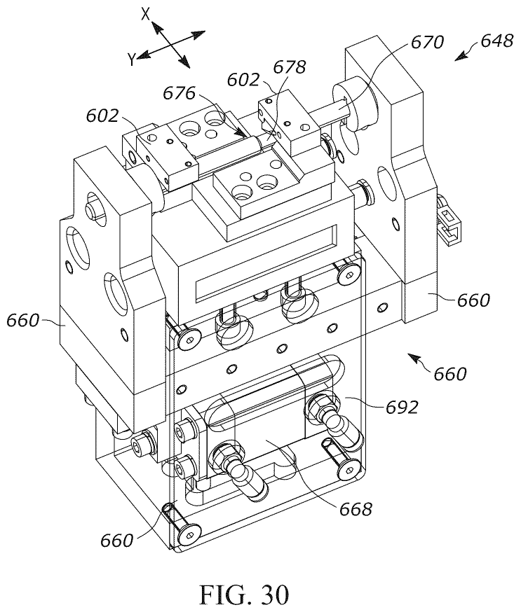

The crimper assembly 414 is illustrated in FIGS. 29-30 and receives u-channeled spacer 405A of a single material and 405B of multiple materials (for example a thermal spacer) as it departs from the roll former 412. The crimper assembly 414 includes a pair of anvils 602 that are used to bias locations along the u-shaped spacer frame 403A, 403B as it travels along the central axis X defined by the path of material flow. In particular, the crimper assembly 414 uses the anvils 602 for deforming the future corner locations where the spacer frame 403 is bent during a finishing operation. Additional discussion of the operation and construction of the spacer frame is shown and described in U.S. Pat. No. 10,184,290, which is incorporated herein in its entirety by reference for all purposes.

The crimper assembly 414 also includes a shuttle arrangement 648 (see FIG. 31) to accommodate the two different types of u-channeled spacer frames 405A, 405B as they enter the crimper. The shuttle 648 rides on a ball screw assembly 610 that advances with the spacer along the process flow X axis while the anvils 602 are collapsing and deforming the spacer 405 on its lateral walls 42, 44 in a direction transverse to the X axis as the spacer travels along the material flow path. In order to accommodate the different types of spacer frames, 405A and 405B, the shuttle arrangement 648 includes a frame or fixture 660, an actuator 668 that translates a shuttle 676 transversely to the X axis about a fixed shaft 670 (see FIG. 31).

The shuttle 648 moves the crimper anvils 602 relative to the shaft 670 so that the u-shaped spacer frame 405 is traveling over a smooth portion of the shaft 676 (when a full metal spacer 405A is being processed) or a grooved portion of the shaft 678 when a thermal spacer 405B having a thermal barrier such that the bead 428 of the spacer rides in the groove during processing.

The shaft 676 near the top of the crimper assembly 414 in the example embodiment of FIG. 31 supports the formed spacer 403 as it leaves the roll former 412. In the second configuration, a groove 678 (see FIG. 31) similar to those discussed in the feeder assembly 410 and roll forming assembly 412 allows translation to occur to move tooling in the crimper 414 in this example embodiment to facilitate the spacer strip material 403B with a thermal barrier 428 to remain coincident and on the central axis X as it passes over the shaft 670 without inducing a bow in the formed spacer during the crimping process. As with the feeder assembly 410 and roll forming assembly 412, switching of the tooling and in particular the shuttle 648 that moves the anvils 602 between first position 672 and second position 674 is further accomplished with a pneumatic cylinder or other actuator 668 located behind the sheet metal front plate 692, as shown in FIG. 30.

### Fourth Station: Cuttoff, Swager, Forming Operations

FIGS. 19-20, 26-27, 32-35 and 40-42 illustrate the fourth finishing stations as spacer frame leaves the crimping station 414 and enters in one example embodiment a cutoff operation 420 or splaying station 416, which includes a swaging operation 418 or forming operation 421 in accordance with one example embodiment of the present disclosure.

Details of the operation and construction of the splaying station 416 and cutoff operation are described and illustrated in U.S. Pat. No. 7,901,526 entitled WINDOW COMPONENT STOCK TRANSFERRING that issued on Mar. 8, 2011 (hereinafter “the '526 patent). The '526 patent is incorporated herein by reference in its entirety for all purposes.

The cutoff operation 420 and swaging operation 418 operate to cut the spacer frame at a prescribed and/or selectable length communicated from the controller 422 or production schedule. After the spacer is cut to the prescribed length, the spacer 403 enters the swaging operation of the fourth finishing station. During the swaging operation 418, the lateral walls are swaged 42, 44 to a taper along a portion of the tab 66 denoted by reference characters S (scc FIG. 3) so that the tab provides friction fit within a portion of the end portion 70.

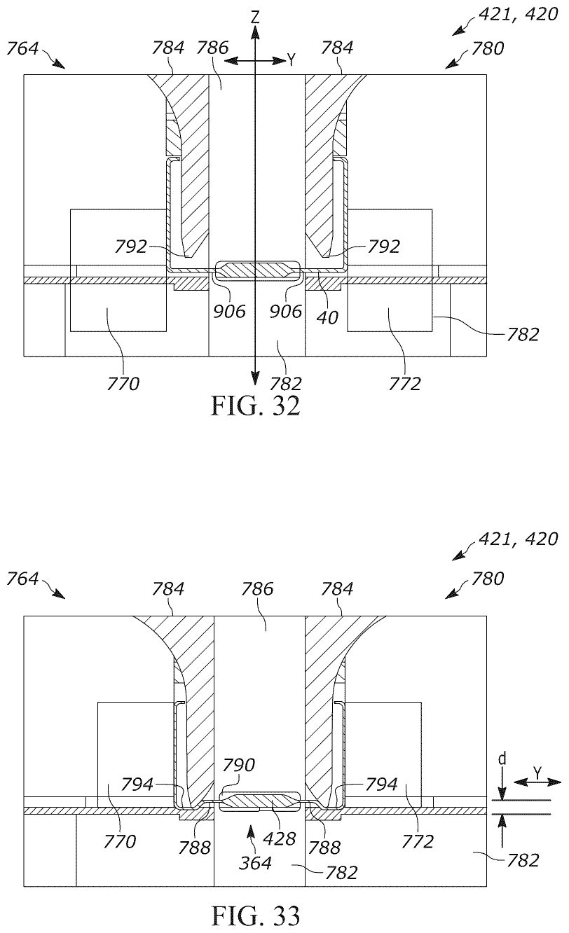

Upon completion of the swaging operation 418, the spacer 403 enters a forming operation 421 within the finishing station to create a unique deformation in the last section of the u-shaped spacer frame 503B so that it can be assembled without and/or minimizing any undesirable gaps in the u-shaped spacer frame 503B when assembled such that the tab 66 is inserted into the spacer end portion 70. The forming tool 764, in one example embodiment of the present disclosure, comprises a moving die assembly 780 and moving anvil 782, as illustrated in FIGS. 32-35. The forming tool 764 is retracted for homogenous metal spacers 503A of the first type to pass through the cutoff assembly 420 as usual and for the metal of the spacer to receive a standard taper, while the thermal u-shaped spacer 503B of the second type receives more extensive forming and support by the tooling 764.

When the u-shaped spacer 503 is scheduled to pass through the cutoff assembly 420, the tools of the cutoff assembly 420 activate to pinch the web of the spacer between a set of cutting dies 780. When cutting is complete, a pair of side roller forming dies 770, 772 deform the spacer web, creating the unique taper configuration allowing the tab 66 to be received by the spacer end 70 when the spacer is in the final assembly operation.

It should be appreciated that in another example embodiment, the anvil die 782 remains in an upward, static position. Stated another way, the anvil die 782 does not move during processing of the thermal spacer frame 503B or metal spacer frame 503A.

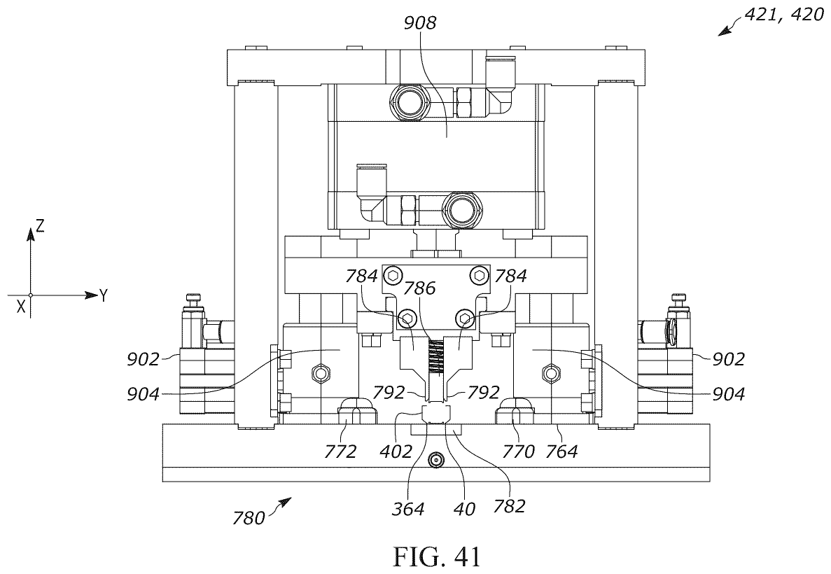

In one example embodiment of the present disclosure, the additional forming operation for deforming the web of the thermal spacer 503B is processed by the die assembly 780, which is a two-stage die having an outer forming die 784 and inner clamping die 786 (see FIG. 32). The u-shaped spacer frame 503 enters the forming station 421 as can be seen in FIGS. 32-35 and 40-42. In FIG. 41, the anvil 782 and die assembly 780 are in a retracted position so that either type of u-shaped spacer 503 can be cut and processed.

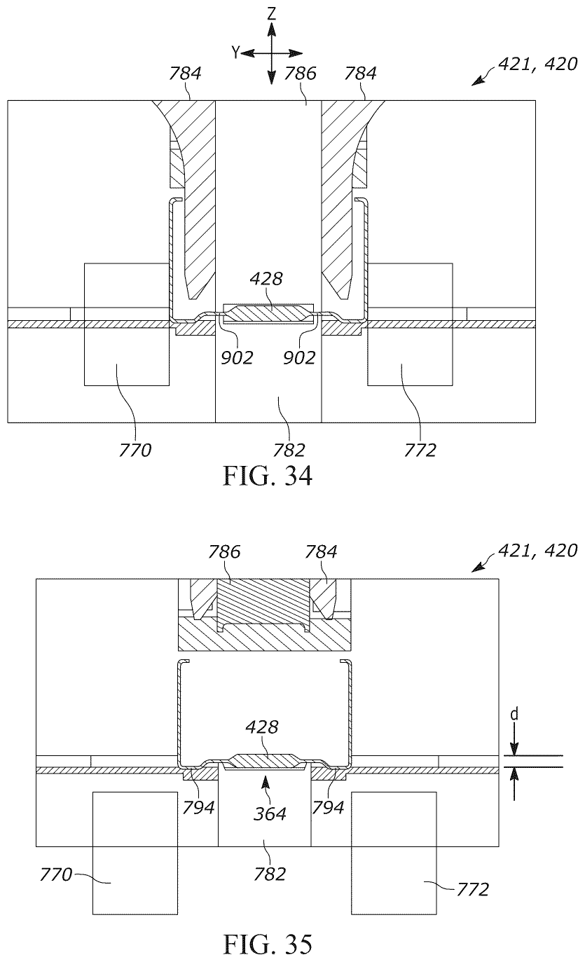

When the spacer frame 503 is a thermal spacer 503B, the spacer enters the forming station 421 when the die assemblies 780 and anvil 782 are in their retracted positions (see FIG. 41). The u-shaped thermal spacer frame 503B is then advanced along the X axis of material flow to be received and supported by the anvil 782, as illustrated in FIG. 32. The anvil 782 is then shifted to an upward position as illustrated in FIGS. 33-34. A first inner clamping die 786 is then lowered onto and in contact with the web portion of the spacer 503B as illustrated in FIGS. 33-34. The first inner die 786 and moving anvil 782 come into contact at points 788 on the spacer 503B (see FIG. 33) to form a cavity 790 around the bead 428 in the inner and outer web of the spacer 503B. The support formed by the cavity 790 from the anvil 782 and inner die 786 fix the spacer 503B into position so that it does not move from the second forming operation by the outer die 784.

The outer die 784 then descends to a second position along a Z axis as illustrated in FIG. 32 transverse to the path of travel defining the X axis and transverse to the lateral Y axis. The inner die 786 path of travel is parallel to the Z axis as well as it moves from the upward position to the contact 788 position illustrated in FIGS. 32, 41 respectively. Wedges 792 in the outer die 784 when translated downward contact the peripheral wall 40 of the spacer 503B forming lobe portions 794 symmetrically about the bead 428 as illustrated in FIGS. 33-35. The additional forming operation 421 for the spacer frame 503B and the creation of the two lobes 794 forms a trough 364 over a limited portion of the tab 66 of the spacer frame as further illustrated in FIG. 41. The trough 364 is the space between the two lateral walls 42, 44 of the spacer 503B with a depth of distance d (see FIGS. 33 and 38) that extends from the planar surface of the lateral axis Y of the peripheral wall 40 (see FIG. 32) and the distance therefrom formed by the lobes 794 made by the wedges 792 forming the distance d. The length of the forming outer dies 784 along the X axis is the distance L illustrated in FIG. 37. This makes clearance for the bead 364 when the ends of the spacer are folded together during final finishing assembly. The trough 364 of the tab 66 and the bead 364 of the spacer end 77 in one example embodiment are pliable materials forming a fluid tight seal therein during final assembly.

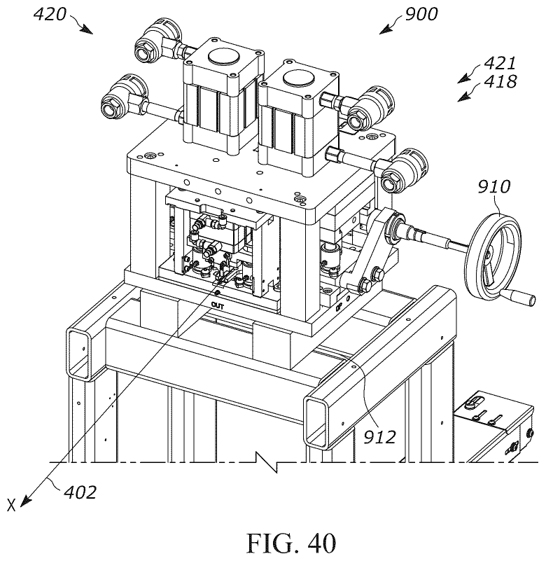

Once the lobes 794 are formed by the wedges 792, the outer dies 784 retract and/or ascend upward (see FIG. 35) to the original position (see FIGS. 40 and 41). After the outer dies 792 are retracted, the inner die 786 ascends to its original position (see FIGS. 35 and 41). After the forming operation 421, the spacer 503 is folded into a finished spacer frame assembly. The lower die or anvil 782 descends to its original position.

In the illustrated example embodiments, unless described otherwise, all dies and anvils are advanced using cylinders (pneumatic and/or hydraulic) with typical metals for molds and dies such as M steels, with die springs and the like, as would be understood by one of ordinary skill in the art having the advantage of reading this specification and reviewing the accompanying drawings. Also, in the illustrated example embodiments, unless described otherwise, all rollers are made with hardened steels, as would be appreciated by one of ordinary skill in the art in which any groove for the bead 428 of the thermal spacer 503B being turned before the hardening process or heat treatment of the steel forming the roller. Actuators coupled to fixtures to shuttle the rollers when switched from a thermal metal strip 403B or u-shaped thermal spacer 503B to a pure metal strip 403A or pure metal spacer 503A are illustrated in the various embodiments by one or more cylinders (pneumatic and/or hydraulic), but it should be appreciated that other types of actuators could be used, such as screw gears, rack and pinion gears, gearing combinations, chain or belt drives, linear magnets, and the like, or any combination thereof.

In one example embodiment, the forming station 421 and assembly 764 are designed for field retrofitting existing spacer frame assembly lines. In another example embodiment, the crimping station 414 is designed for field retrofitting existing spacer frame assembly lines. In yet another example embodiment, the roll forming station 412 roll form press is designed for field retrofitting existing spacer frame assembly lines. While in another example embodiment, the feeder press 410 is designed for field retrofitting existing spacer frame assembly lines.

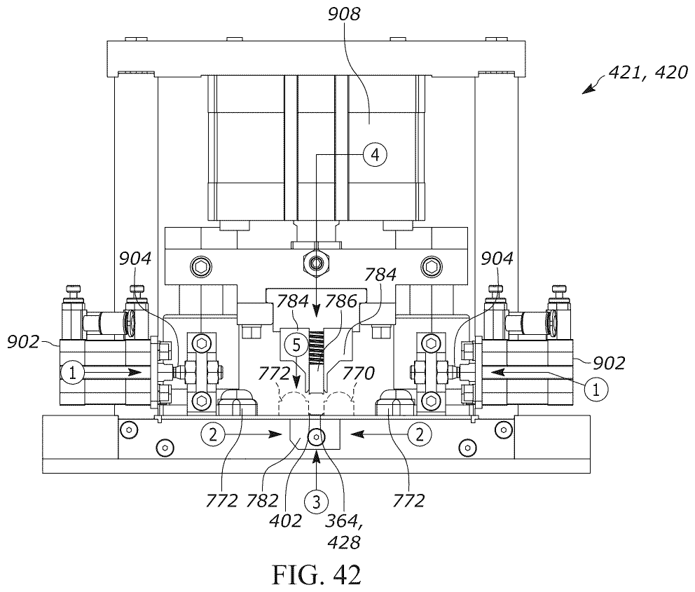

In yet another example embodiment, as illustrated in FIG. 42, when the presence of a thermal spacer 402 is detected by, for example sensor 453, the forming station 421 swaging operation is commenced (although allows full metal spacers to pass through without operation). Operation of the forming station 421 is initiated by lowering die cylinders 902 to extend (see arrows 1) to slide lower die arms 904 toward one another (see arrows 2). This will advance side roller dies to contact and support the thermal spacer frame 402 during swaging. A cylinder then advances the lower clamp or anvil 782 upward to in which the anvil teeth 906 clamp and support the thermal spacer frame 402 (see arrow 3). Upper die cylinder 908 advances downward inner die 786 to clamp and support the thermal spacer frame 402 from above (see arrow 4). The outer upper die 784 then are extended further downward by the upper die cylinder 908 creating the offset swage to the nose or tab end member, allowing the end members of the spacer frame to form a telescopic connection as shown in the cross section in FIG. 52.

In the forming operation of FIG. 42, the support roller dies 770 and 772 are advanced inward by independent cylinders 902 in accordance with one example embodiment. The support roller dies prevent the un-splaying of the nose end, tab, or tongue 56 of the spacer frame. In another example embodiment, FIGS. 32-35 illustrate the support rollers 770 and 772 advancing to support, then retracting by moving up and down with a cylinder (not shown). Of course it would be appreciated by one of ordinary skill in the art having the benefit of this disclosure and drawings to design rollers that are stationary throughout the swaging operation.

Illustrated in FIG. 40 is a crimper cutoff assembly 414 with a swaging arrangement 418 for retro-fitting assembly lines 400 that produce full metal spacer frames to also fabricate thermal spacer frames 402 via a swaging operation 900 in accordance with one example embodiment of the present disclosure. The swaging arrangement 418 includes a swaging assembly 900 that is mounted to a frame with a transfer slide 912 when operated by a drive 910, which allows the swaging operation 900 to translate away from the path of travel of the metal spacer when being processed on an assembly line 400 and the swaging is not needed. Then drive 910 then translates the swaging arrangement 418 into the path of travel of a thermal spacer frame assembly so that the swaging operation 900 as described herein can by employed on the nose, tab, or tongue 56 of the frame assembly in any of the forementioned embodiments.

In one example embodiment, the drive 910 is a manual handle. In another example embodiment, the drive is operated by a motor coupled to a controller 422.

### Method of Operation

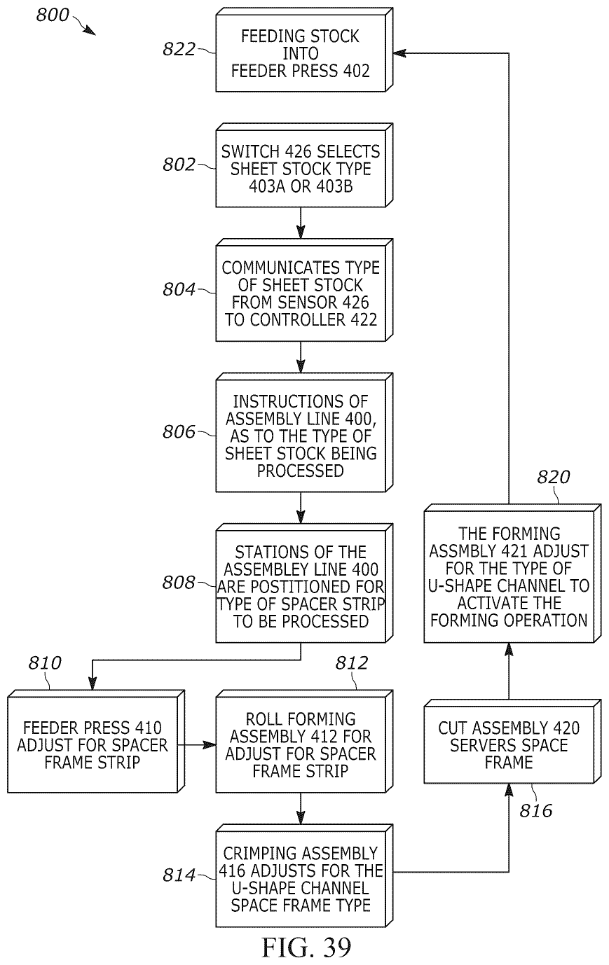

A typical method of operation 800 of the assembly line 400 will now be described as further illustrated in FIG. 39. In the first step 802 of the method 800, a material selection is made for the sheet stock type that is entering the assembly line 400. One of ordinary skill of the art will recognize, after reviewing the contents of the present disclosure, that the selection is made by a manual switch 426A, a sensor 426B, or a production schedule programmed into the controller 422. One would understand that the sensor 426B of the present disclosure includes a sensor 453, barcode scanner, or that the components of the assembly line 400 can be pre-programmed to accept various spacer stock types without use of a sensor.

At step 804, the manual switch/sensor 426 communicates the spacer stock type 403A, B to the controller 422. Based on the feedback from the sensor, at step 806, the controller selects one of a plurality of pre-set configurations for each of the stations for the assembly line 400. The pre-set configurations are based on material type, material width, material thickness, and/or material dimensions, and any combination thereof. At step 808, the forthcoming spacer strip each of the stations of the assembly line 400 are positioned for the spacer strip type 403A, B selected by the switch 426 to be processed by each of the stations.

At step 810, the feeder press assembly 410 adjusts the positions of the rollers for the type of sheet stock 403A, B to one of a plurality of pre-set positions so that the spacer stock 403A, B is in position to go through the feeder press 410 station as outlined above without damage to the shape and/or material. At step 812, the roll forming assembly 412 adjusts positions of the rollers to accept the spacer strip 403A, B to pass through said roll forming assembly for forming as outlined above. At step 814, a crimping assembly 414 accepts the spacer strip 403A, B to pass through said crimping assembly 414 as outlined above. At step 816, the cutoff assembly 420 recognizes the length of the spacer to be cut and severs each spacer at the prescribed length when the material is fed through the final finishing station. At 820 the forming operation recognizes the type of u-shaped spacer frame 503A, B and if a 503B thermal spacer is being processed, actuating the dies 780 and anvil 602 to form a channel over a portion of the tab 66 of the spacer frame 402. At step 822, the sheet stock 403A, B is fed into the feeder press assembly 402 and the operation commences for processing the proper type of spacer frame through each operation of the assembly line 400.

It is contemplated in the spirit and scope of the present disclosure that the assembly line 400 components outlined above can be installed, in one example embodiment, into an existing assembly line for constructing an IGU and replace the pre-existing components previously installed in the traditional IGU assembly line.

Those of ordinary skill in the art will conceive of other alternate embodiments of the invention upon reviewing this disclosure. Thus, the invention is not to be limited to the above description but is to be determined in scope by the claims which follow.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way, but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E1, E2, . . . En and that each embodiment E may have multiple parts A1, B1, C1 . . . Zn that (without further description) could be combined with other embodiments En, embodiment parts e.g. A1, C1, or lack of parts originally associated with one or all embodiments En, or any combination of parts and/or embodiments thereof. It should further be appreciated that an embodiment En may include only one part e.g. A1 or a lesser number of parts e.g. B1, C1 of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A spacer frame assembly comprising:
a substantially linear channel made from a first material and a second material wherein said second material stands proud on first and second sides of a plane formed by said first material, the substantially linear channel having first and second ends, the substantially linear channel that when assembled, includes at least three sides with corresponding corners between each of said sides;
a connecting structure located at one of said first and second ends and an opposite frame end located at the other of said one of first and second ends, the opposite frame end having an inner channel for receiving a tab portion of said connecting structure;
a lateral connection spaced from said corresponding corners and along one of said at least three sides, the lateral connection forming a union between said opposite frame end and said connecting structure; and
a peripheral wall, spacing and connecting first and second lateral walls forming the three sides of said lateral channel, a trough formation being formed along substantially the lateral connection on said peripheral wall of said connecting structure.

2. The spacer frame assembly of claim 1 wherein said trough formation along the lateral connection comprises an arcuate cavity along a portion of said second material on the outside of the channel of the peripheral wall of said tab.

3. The spacer frame assembly of claim 1 wherein said trough formation along the lateral connection comprises a protuberance on the inside of the channel of the peripheral wall and a recess on the outside wall along a portion of the tab in said second material.

4. The spacer frame assembly of claim 1 wherein said trough formation along the lateral connection comprises a protuberance on the inside of the channel of the peripheral wall and a trough on the outside of the channel of the peripheral wall.

5. The spacer frame assembly of claim 4 wherein said trough formation along the lateral connection comprises a single protuberance on the inside of the channel of the peripheral wall and a double protuberance projecting from the trough on the outside of the channel of the peripheral wall.

6. A method of drawing differing sheet stock through a feeder press station, the method comprising the steps of:
feeding an elongated length of sheet stock from an uncoiler into a feeder press;
drawing said elongated length of sheet stock through a set of pinch rollers along a process axis formed by a path in which the sheet stock travels during processing; and
translating said pinch rollers from a first position to a second position to accommodate the processing of different types of sheet stock, wherein said translating occurs in a direction transverse to said process axis.

7. The method of claim 6 further comprising the step of:
providing a splined axle to transfer torque to one of said pinch rollers and for translating said pinch roller along said splined axle from said first position to said second position.

8. A method of roll forming differing sheet stock through a roll forming station, the method comprising the steps of:
feeding an elongated length of sheet stock from a feeder roller into a roll former;
drawing said elongated length of sheet stock through a plurality of roll forming dies along a process axis formed by a path in which the sheet stock travels during processing; and
translating a drive roller from a first position to a second position to accommodate different types of sheet stock, wherein said translating is in a direction transverse to said process axis.

9. The method of claim 8 further comprising the step of:
providing a splined axle to transfer torque to said drive roller and for translating said drive roller along said splined axle from said first position to said second position.

10. A method of forming a portion of a thermal spacer frame, the method comprising the steps of:
feeding a u-shaped formed spacer frame from a feed roller into a forming station;
advancing an anvil along a direction transverse to an axis defined by a flow of material to a position in which said anvil engages said u-shaped formed spacer frame;
advancing a first die along a second axis formed said direction transverse to said axis defined by said flow of material to a position in which said first die engages said u-shaped spacer frame;
advancing a second die along said second axis formed said direction transverse to said axis defined by said flow of material to a position in which said second die engages said u-shaped spacer frame such that a plane is formed by contact of said u-shaped spacer and said first die, said second die, and said anvil; and
further advancing said second die along said second axis beyond said plane to form a channel in a portion of a peripheral wall of said u-shaped channel.

11. The spacer frame assembly of claim 1, wherein a portion of said tab include a formed region to allow for the protuberance of the end portion, the formed region located within said peripheral wall of said spacer frame having a first and second formed planar surfaces of said first material spaced by an inward non-planar trough, said inward non-planar trough comprising said first and second materials.

12. The spacer frame assembly of claim 1, wherein said first material has a first coefficient of heat transfer and said second material has a second coefficient of heat transfer that is less than said first coefficient of heat transfer.

13. The spacer frame assembly of claim 1, wherein said first material has a first coefficient of heat transfer and said second material has a second coefficient of heat transfer that is less than said first coefficient of heat transfer.

14. The spacer frame assembly of claim 1, wherein said first material has a first coefficient of heat transfer and said second material has a second coefficient of heat transfer that is less than said first coefficient of heat transfer.

15. The spacer frame assembly of claim 1, wherein said second material is formed from a thermal barrier having a non-linear cross-section of one wall and further wherein said first material is formed having a linear cross-section along all walls.

16. The spacer frame assembly of claim 1, wherein said first material is metallic and said second material is polymeric.

17. A system comprising an assembly line for manufacturing a metallic spacer frame and a thermal spacer frame from a continuous sheet stock that is formed into a spacer frame through a series assembly stations comprising:
a feeder press station that receives an elongated length of continuous sheet stock from an uncoiler during use;
a set of pinch rollers along a having process axis formed by a path in which the continuous sheet stock travels during processing;
said pinch rollers comprise a transfer assembly for translating from a first position to a second position to accommodate the processing of different types of continuous sheet stock, wherein said translating occurs in a direction transverse to said process axis;
a roll forming station for receiving said continuous sheet stock from said feeder roller station into a roll former arrangement;
said roll former arrangement comprising a plurality of roll forming dies along said process axis formed by a path in which the continuous sheet stock travels during processing; and
a drive roller that translates from a first position to a second position to accommodate different types of continuous sheet stock, wherein said translating is in a direction transverse to said process axis; and
a swaging station comprising said process axis formed by the continuous sheet stock;
an anvil and two-stage die assembly that are activated when said continuous sheet stock includes a thermal barrier, the anvil and two-stage die assembly generating a formed trough in a portion of said continuous sheet stock during operation.

18. The system of claim 17 wherein said assembly line further comprises a splaying station having said process axis for forming the nose of a metallic spacer frame and a thermal spacer frame during operation.

19. The system of claim 17 wherein said assembly line further comprises a crimping station having said process axis for crimping a metallic spacer frame and a thermal spacer frame during operation.

20. The system of claim 17 wherein said assembly line further comprises a cutoff station having said process axis for selectively cutting a metallic spacer frame and a thermal spacer frame to a desired length during operation.
